(19) United States
(12) Patent Application Publication
(10) Pub. No.: US 2013/0178115 A1
(43) Pub. Date: Jul. 11, 2013

(54) CONNECTOR

(71) Applicant: HOSIDEN CORPORATION, Osaka (JP)

(72) Inventors: Hitoshi AO, Osaka (JP); Hayato KONDO, Osaka (JP)

(73) Assignee: HOSIDEN CORPORATION, Osaka (JP)

(21) Appl. No.: 13/731,300

(22) Filed: Dec. 31, 2012

(30) Foreign Application Priority Data
Jan. 6, 2012 (JP) 2012-001594

(51) Int. Cl. H01R 13/646

(52) U.S. Cl. CPC H01R 13/646
USPC 439/682

(57) ABSTRACT

The invention provides a connector including first and second contacts having substantially the same overall length. The first and second contacts each include a contact portion, a first straight portion extending in a first direction, a first bent portion bent in a direction including a second direction, an intermediate portion, a second bent portion bent in a direction including a third direction, a second straight portion extending in the direction including the third direction, and a tail. In the second contact, the contact portion is spaced apart in the third direction from the contact portion of the first contact, the first straight portion has a larger length than the first straight portion of the first contact, the second straight portion has a smaller length than the second straight portion of the first contact, and the tail is spaced apart in the first direction from the tail of the first contact.

The present application claims priority under 35 U.S.C. §119 of Japanese Patent Application No. 2012-001594 filed on Jan. 6, 2012, the disclosure of which is expressly incorporated by reference herein in its entity.

### BACKGROUND OF THE INVENTION

1. Technical Field

The invention relates to connectors.

2. Background Art

Japanese Unexamined Patent Publication No. 2011-138775 discloses a connector having generally L-shaped first and second contacts that constitute a differential pair. The first and second contacts each include a contact portion, a first straight portion continuous with the contact portion, a second straight portion being continuous with the first straight portion and extending in a direction orthogonal to the first straight portion, and a tail continuous with the second straight portion. The first straight portion of the second contact has a larger length than the first straight portion of the first contact. A bent portion is provided in the middle of the first straight portion of the second contact to avoid interference with the second straight portion of the first contact. The second straight portion of the first contact has a larger length than the second straight portion of the second contact by the difference in length between the first straight portion of the second contact and the first straight portion of the first contact. With such a configuration, the overall length of the first contact is substantially the same as the overall length of the second contact, preventing occurrence of skew between the first and second contacts.

### SUMMARY OF INVENTION

A drawback of the above conventional connector is significant difference in shape between the first and second contacts because the first straight portion of the second contact and the second straight portion of the first contact cross each other in a three-dimensional manner. It is therefore difficult to press-mold the first and second contacts at a time, requiring a plurality of press-molding dies. This causes increased costs of the connector.

The invention has been made in consideration of the above circumstances. The invention provides a connector capable of reducing the occurrence of skew between the first and second contacts and being manufactured with reduced costs.

A connector according to an aspect of the invention includes a body of insulation and first and second contacts being adapted to be held in the body and having substantially the same overall length. The first contact includes a contact portion; a first straight portion being continuous with the contact portion and extending in a first direction; a first bent portion being continuous with the first straight portion and bent in a direction including a component of a second direction, the second direction being orthogonal to the first direction; an intermediate portion being continuous with the first bent portion; a second bent portion being continuous with the intermediate portion and bent in a direction including a component of a third direction, the third direction being orthogonal to the first and second directions; a second straight portion being continuous with the second bent portion and extending in the direction including the component of the third direction; and a tail being continuous with the second straight portion. The second contact includes a contact portion being spaced apart in the third direction from the contact portion of the first contact; a first straight portion being continuous with the contact portion of the second contact, extending in the first direction, and having a larger length than the first straight portion of the first contact; a first bent portion being continuous with the first straight portion of the second contact and bent in the same direction as the bending direction of the first bent portion of the first contact; an intermediate portion being continuous with the first bent portion of the second contact; a second bent portion being continuous with the intermediate portion of the second contact and bent in the same direction as the bending direction of the second bent portion of the first contact; a second straight portion being continuous with the second bent portion of the second contact, extending along the second straight portion of the first contact, and having a smaller length than the second straight portion of the first contact; and a tail being continuous with the second straight portion of the second contact and being spaced apart in the first direction from the tail of the first contact.

In this aspect of the invention, the respective portions of the first and second contacts are configured such that the contact portions are spaced apart in the third direction from each other, and the first straight portions extend in the first direction; the first bent portions are bent in the direction including a component of the second direction, and the second bent portions are bent in the direction including a component of the third direction; the intermediate portions are each disposed between the first and second bent portions; the second straight portions extend in the direction including the component of the third direction, and the tails are spaced apart from each other in the first direction; and the first straight portion of the second contact has a larger length than that of the first contact, and the second straight portion of the second contact has a smaller length than that of the first contact. In short, the first and second contacts are arranged substantially in parallel to each other throughout their lengths, which leads to reduced occurrence of skew between the first and second contacts. Further, the first and second contacts, shaped substantially in parallel to each other throughout their lengths, can be manufactured at a time by press-molding. This contributes to reduction in number of dies for manufacturing the first and second contacts, resulting in reduced costs of the connector. Still further, the first and second contacts, arranged substantially in parallel to each other throughout their lengths, are advantageously easy to adjust impedances between them.

The first and second bent portions of the first and second contacts may be smoothly bent.

The length of the second straight portion of the second contact may be smaller than the length of the second straight portion of the first contact by substantially the same amount as the difference in length between the first straight portion of the first contact and the first straight portion of the second contact.

The connector may further include a third contact held in the body. The third contact may be disposed in spaced relation to the first straight portions of the first and second contacts in the second direction or a direction opposite to the second direction so as to extend substantially in parallel to the first straight portions of the first and second contacts.

In this aspect of the invention, the third contacts can function as a ground contact or a pseudo ground contact for the first and second contacts. Therefore, this aspect of the invention further contributes to matched impedances between the first and second contacts.

The third contact may be disposed in a region defined between the first straight portions of the first and second contacts and the second straight portions of the first and second contacts.

In this aspect of the invention, the third contact contributes to reduction in cross talk that may occur between the first straight portions of the first and second contacts and the second straight portions of the first and second contacts. Further, as the region to dispose the third contact is otherwise unused space in the connector, the addition of the third contact does not cause increase in dimension of the connector in the second direction.

The third contact may include a contact portion; a straight portion being continuous with the contact portion of the third contact, extending in the first direction, and spaced apart in the second direction from the first straight portions of the first and second contacts; an inclined portion being continuous with the straight portion and obliquely inclined with respect to the straight portion, the inclined portions being disposed between the first straight portions of the first and second contacts and the second straight portions of the first and second contacts; and a tail being continuous with the inclined portion.

In this aspect of the invention, the third contact is situated in such a manner as to reduce cross talk between the first straight portions of the first and second contacts and the second straight portions of the first and second contacts. Moreover, as the straight portion of the third contact is spaced apart in the second direction from the first straight portions of the first and second contacts, the third contact can function as a ground contact or a pseudo ground contact for the first and second contacts. Therefore, this aspect of the invention contributes to matched impedances between the first and second contacts.

The inclined portion of the third contact may extend substantially in parallel to the intermediate portions of the first and second contacts.

The first and second contacts tend to have higher impedances in their first and second bent portions and intermediate portions than in their first and second straight portions. However, the above-mentioned aspect of the invention can reduce impedances in the first and second bent portions and the intermediate portion because the inclined portion of the third contact is disposed substantially in parallel to the intermediate portions of the first and second contacts. Therefore, this aspect of the invention also contributes to matched impedances between the first and second contacts.

The body may include a first body for holding the contact portions and the first straight portions of the first and second contacts; and a second body for holding the second straight portions of the first and second contacts. This aspect of the invention makes it possible to bend the first and second bent portions of the first and second contacts in the state where the first body holds the contact portions and the first straight portions of the first and second contacts, while the second body holds the second straight portions of the first and second contacts. It is therefore possible to minimize variations in shape and/or disposition of the first and second contacts.

Alternatively, the body may include the body includes a first body for holding the contact portions and the first straight portions of the first and second contacts; a second body for holding the second straight portions of the first and second contacts; and a third body for holding the inclined portion of the third contact, the third body being disposed between the first and second bodies.

In this aspect of the invention, when the first and second bent portions of the first and second contacts are bent in the state where the first body holds the contact portions and the first straight portions of the first and second contacts and the second body holds the second straight portions of the first and second contacts, the third body holding the inclined portion of the third contact is disposed between the first and second bodies. This aspect of the invention thus eases assembly of the connector. Further, it is possible to bend the first and second bent portions of the first and second contacts in the state where the first body holds the contact portions and the first straight portions of the first and second contacts and the second body holds the second straight portions of the first and second contacts. It is therefore possible to minimize variations in shape and/or disposition of the first and second contacts.

The connector may further include a shell with electrical conductivity for surrounding the body. The intermediate portions of the first and second contacts may be exposed from the body. The shell may include an impedance adjusting portion to be disposed in the vicinity of the intermediate portions of the first and second contacts.

In this aspect of the invention, as the impedance adjusting portion is disposed in the vicinity of the intermediate portions of the first and second contacts, it is possible to reduce the impedances of the impedance of the first and second bent portions and the intermediate portions. Therefore, this aspect of the invention also contributes to matched impedances between the first and second contacts.

Alternatively, the connector may further include a shell with electrical conductivity for surrounding the body and a dielectric member. The dielectric member may be disposed between the intermediate portions exposed from the bodies of the first and second contacts and the shell.

In this aspect of the invention, the dielectric, disposed between the intermediate portions exposed from the bodies of the first and second contacts and the shell, can reduce the impedances of the first and second bent portions and the intermediate portions. Therefore, this aspect of the invention also contributes to matched impedances between the first and second contacts.

The connector may further include first and second differential pairs and a fourth contact. Each of the differential pairs may include the first and second contacts arranged in spaced relation in the third direction. The fourth contact may be disposed between the first and second differential pairs. The third contact may include a plurality of the third contacts. The third contacts may be arranged in the above-described region in such a manner that the straight portions thereof are located between the first straight portions of the first and second contacts of the first differential pair, between the first straight portions of the first and second contacts of the second differential pair, between the first straight portion of the second contact of the first differential pair and the fourth contact, and between the first straight portion of the first contact of the second differential pair and the fourth contact.

The contact portions and the first straight portions of the first and second contacts may be fixed to the body. The inclined portions of the third contacts may be fixed to the body. The straight portions of the third contacts may be elastically deformable toward the first straight portions of the first and second contacts.

The first bent portions of the first and second contacts may be bent in a direction including components of the first, second, and third directions. The intermediate portions of the first and second contacts may extend in the direction including components of the first, second, and third directions.

### BRIEF DESCRIPTION OF DRAWINGS

FIG. 1A is a schematic perspective view showing the front, top, and right side of a connector in accordance with a first embodiment of the invention.

FIG. 1B is a schematic perspective view showing the back, top, and left side of the connector.

FIG. 1C is a schematic perspective view showing the front, bottom, and right side of the connector.

FIG. 1D is a schematic perspective view showing the back, bottom, and left side of the connector.

FIG. 2A is a schematic perspective view showing the front, top, and right side of the first, second, and third bodies and first and second contact groups of the connector.

FIG. 2B is a schematic perspective view showing the back, top, and left side of the first, second, and third bodies and the first and second contact groups of the connector.

FIG. 3A is a schematic perspective view showing the front, top, and right side of the first and second bodies and the first contact group of the connector.

FIG. 3B is a schematic perspective view showing the back, top, and left side of the first and second bodies and the first contact group of the connector.

FIG. 4A is a schematic perspective view showing the front, top, and right side of the third body and the second contact group of the connector.

FIG. 4B is a schematic perspective view showing the back, top, and left side of the third body and the second contact group of the connector.

FIG. 5A is a front view of the first and second contact groups of the connector, showing the layout of contacts of the first and second contact groups.

FIG. 5B is a back view of the first and second contact groups of the connector, showing the layout of the contacts of the first and second contact groups.

FIG. 5C is a right side view of the first and second contact groups of the connector, showing the layout of the contacts of the first and second contact groups.

FIG. 5D is a left side view of the first and second contact groups of the connector, showing the layout of the contacts of the first and second contact groups.

FIG. 5E is a plan view of the first and second contact groups of the connector, showing the layout of the contacts of the first and second contact groups.

FIG. 5F is a bottom view of the first and second contact groups of the connector, showing the layout of the contacts of the first and second contact groups.

FIG. 5G is a perspective view of the first and second contact groups of the connector as viewed from the β direction in FIG. 5C, showing the layout of the contacts of the first and second contact groups.

FIG. 6A is a sectional view taken along 6A-6A in FIG. 1B.

FIG. 6B is a sectional view taken along 6B-6B in FIG. 1B.

FIG. 6C is a sectional view taken along 6C-6C in FIG. 1B.

FIG. 7 is a schematic partial sectional view showing a modified connector.

### DESCRIPTION OF EMBODIMENTS

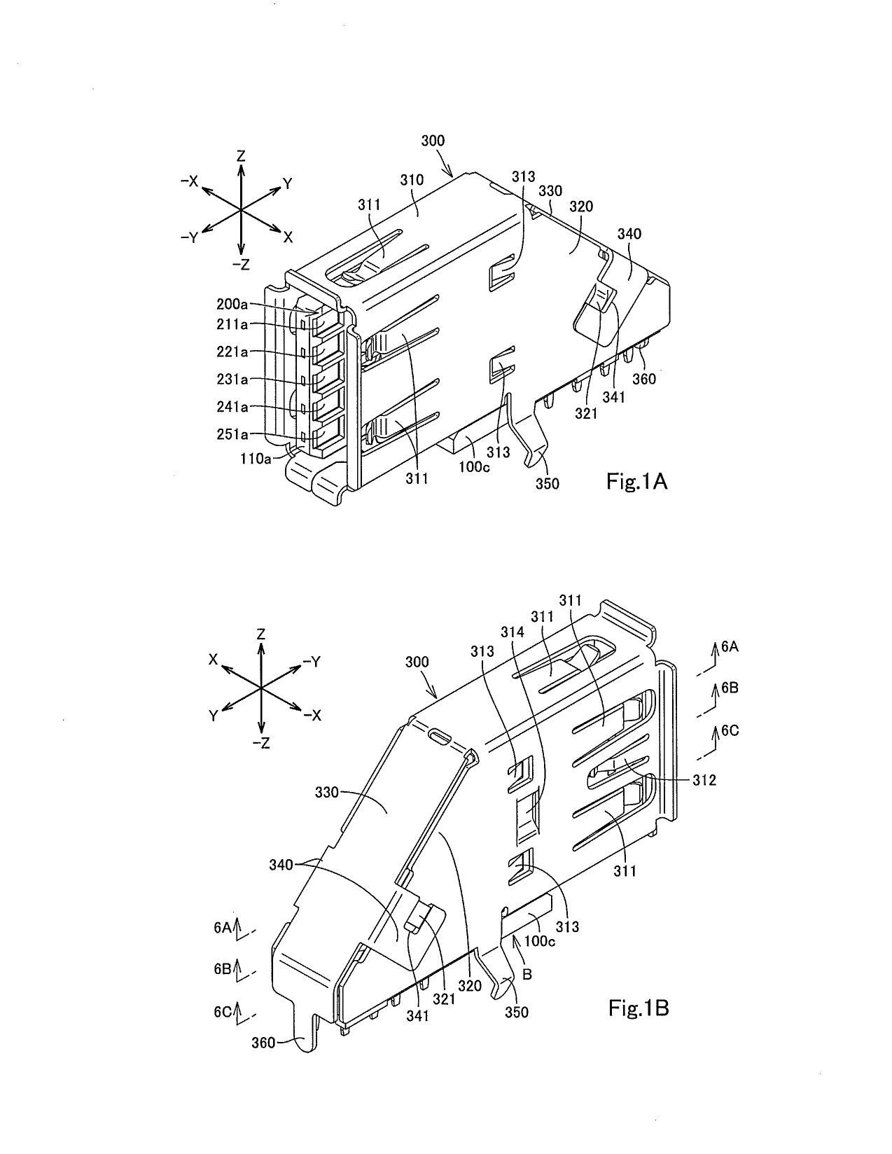

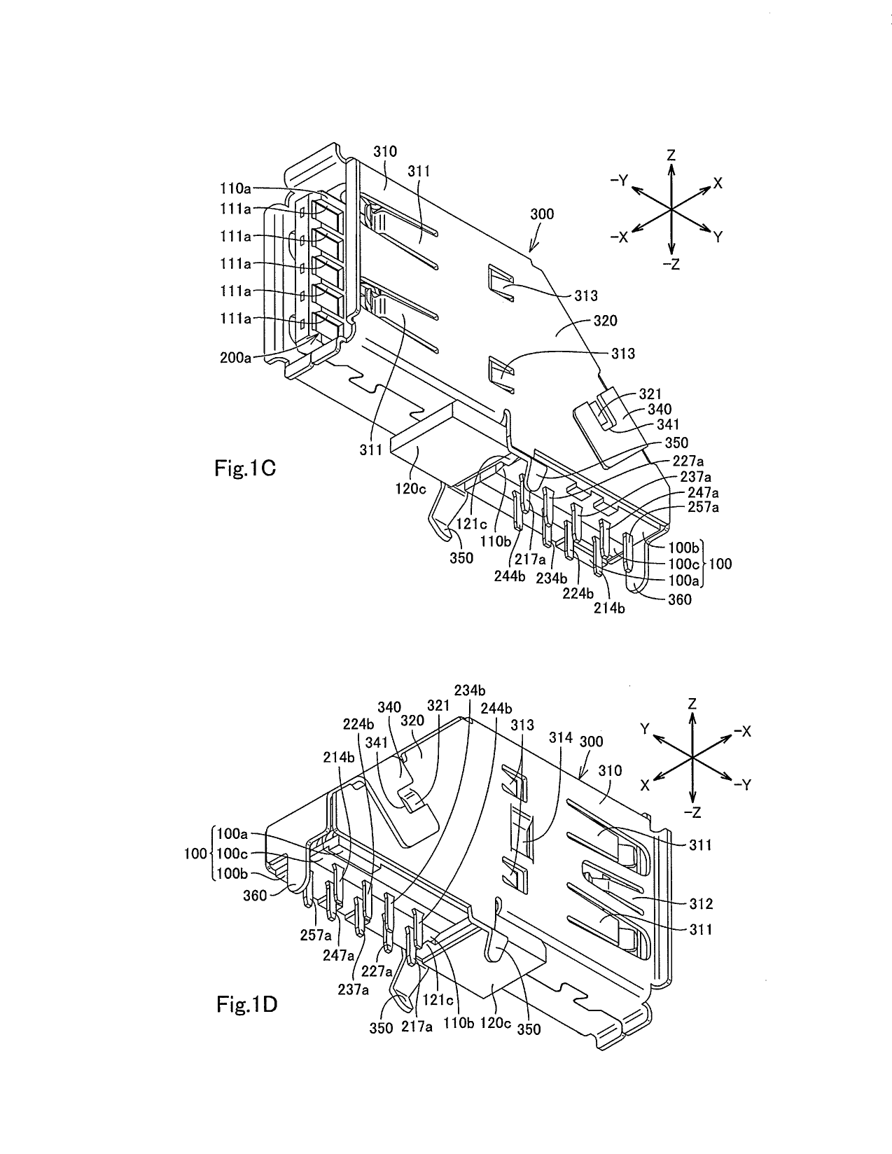

A connector in accordance with a first embodiment of the invention will be described below with reference to FIG. 1A to FIG. 6C.

### First Preferred Embodiment

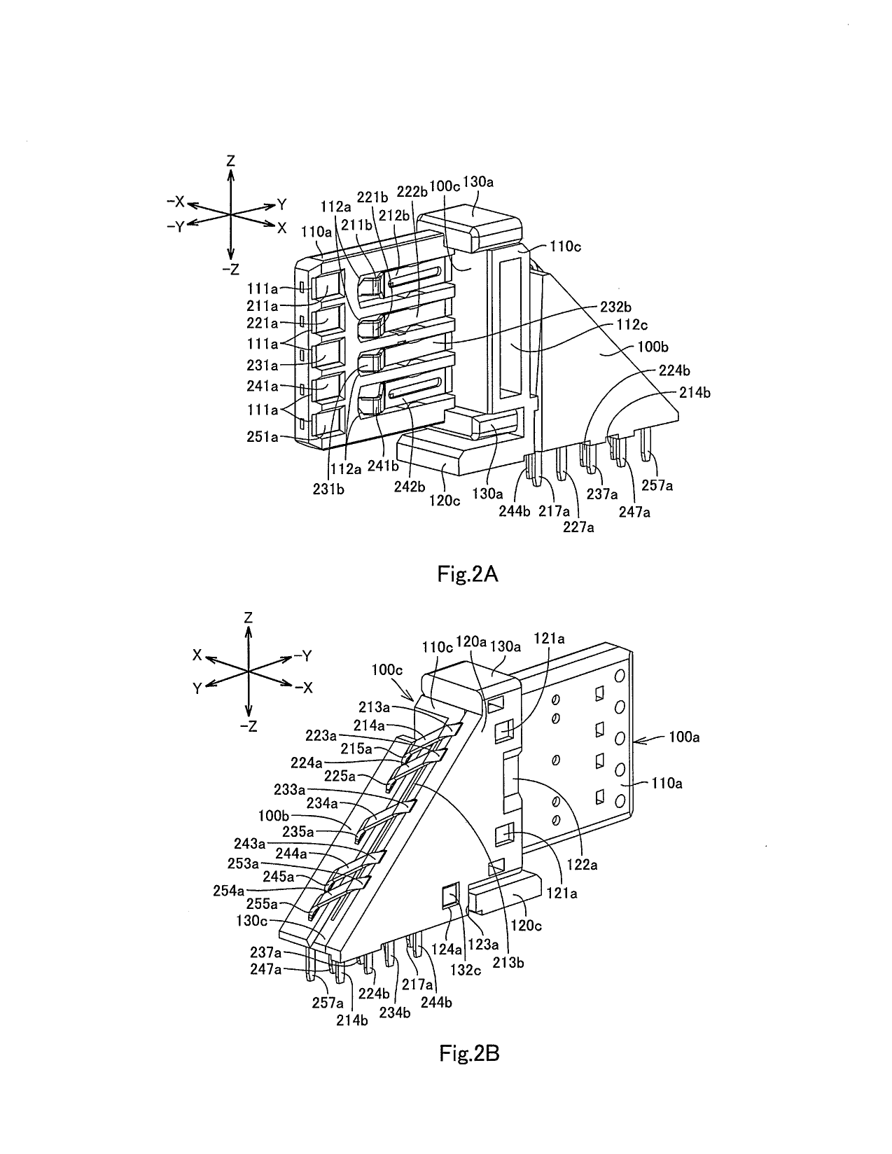

The connector shown in FIG. 1A to FIG. 1D is a receptacle connector that is mountable on a circuit board (not shown). The connector includes a body 100, first and second contact groups 200a, 200b, and a shell 300. Each constituent of the connector will be described in detail below. In FIG. 1A to FIG. 2B, a width direction of the connector is represented as X and −X directions, a depth direction of the connector is represented as Y and −Y directions, and a height direction the connector is represented as Z and −Z directions. The Y and −Y directions are orthogonal to the X and −X directions, and the Z and −Z directions are orthogonal to the Y and −Y directions and the X and −X directions. The Y, X, −X, and −Z directions corresponds to a first direction, a second direction, the direction opposite to the second direction, a third direction, respectively, that are introduced in the Claims.

As shown in FIG. 2A and FIG. 2B, the body 100 has first, second and third bodies 100a, 100b and 100c, which are made of insulating resin.

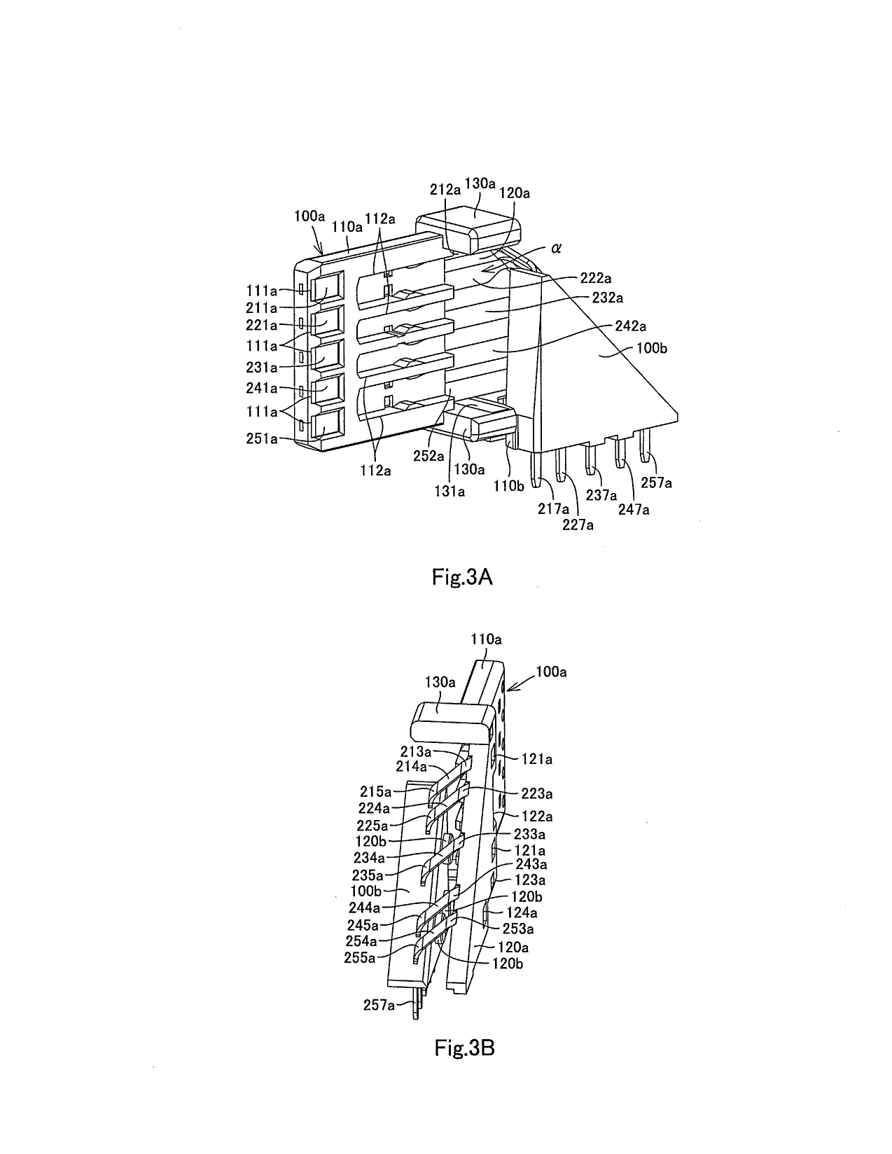

As shown in FIG. 3A and FIG. 3B, the first body 100a has a distal portion 110a, a proximal portion 120a, and a pair of arms 130a. The distal portion 110a is a generally rectangular plate. Five recesses 111a and four grooves 112a are provided in the surface in the X direction of the distal portion 110a. The recesses 111a are rectangular recesses opening in the −Y direction and are spaced apart from each other in the Z and −Z directions. The grooves 112a are long grooves extending in the Y and −Y directions. Each of the grooves is disposed between adjacent two recesses 111a and further in the Y direction.

The proximal portion 120a is a plate of generally right-angled triangle shape, provided continuously with the Y direction end of the distal portion 110a. The proximal portion 120a is smaller in the X and −X directions than the distal portion 110a. As shown in FIG. 2B, the −X direction face of the proximal portion 120a is provided with a pair of locking holes 121a and an locking recess 122a. The locking holes 121a are rectangular holes. The locking recess 122a is an elongated recess extending in the Z and −Z directions and being located between the locking holes 121a. The −Z direction end of the proximal portion 120a has a rectangular notch 123a. On the Y direction side of the notch 123a, there is a rectangular fitting hole 124a passing from the X direction face to the −X direction face of the proximal portion 120a. The hypotenuse side of the proximal portion 120a has a sloped face.

As shown in FIG. 3A, the arms 130a are of rectangular parallelepiped shape and extend in the X direction so as to be opposed to each other. One of the arms 130a is continuous with the Z direction end of the proximal portion 120a, and the other arm 130a is continuous with an edge of the notch 123a of the proximal portion 120a. The opposed surfaces of the arms 130a each have an locking hole 131a (one of the holes is shown). The Y direction end of the distal portion 110a, the proximal portion 120a, and the arms 130a define an accommodation space a.

The second body 100b is a plate generally of right-angled triangle shape. As shown in FIG. 3A, a lower end (the −Z direction end) of the −Y direction face of the second body 100b is provided with a locking protrusion 110b. As shown in FIG. 3B, the −X direction face of the second body 100b has three cylindrical fitting protrusions 120b. The hypotenuse side of the second body 100b has a sloped face.

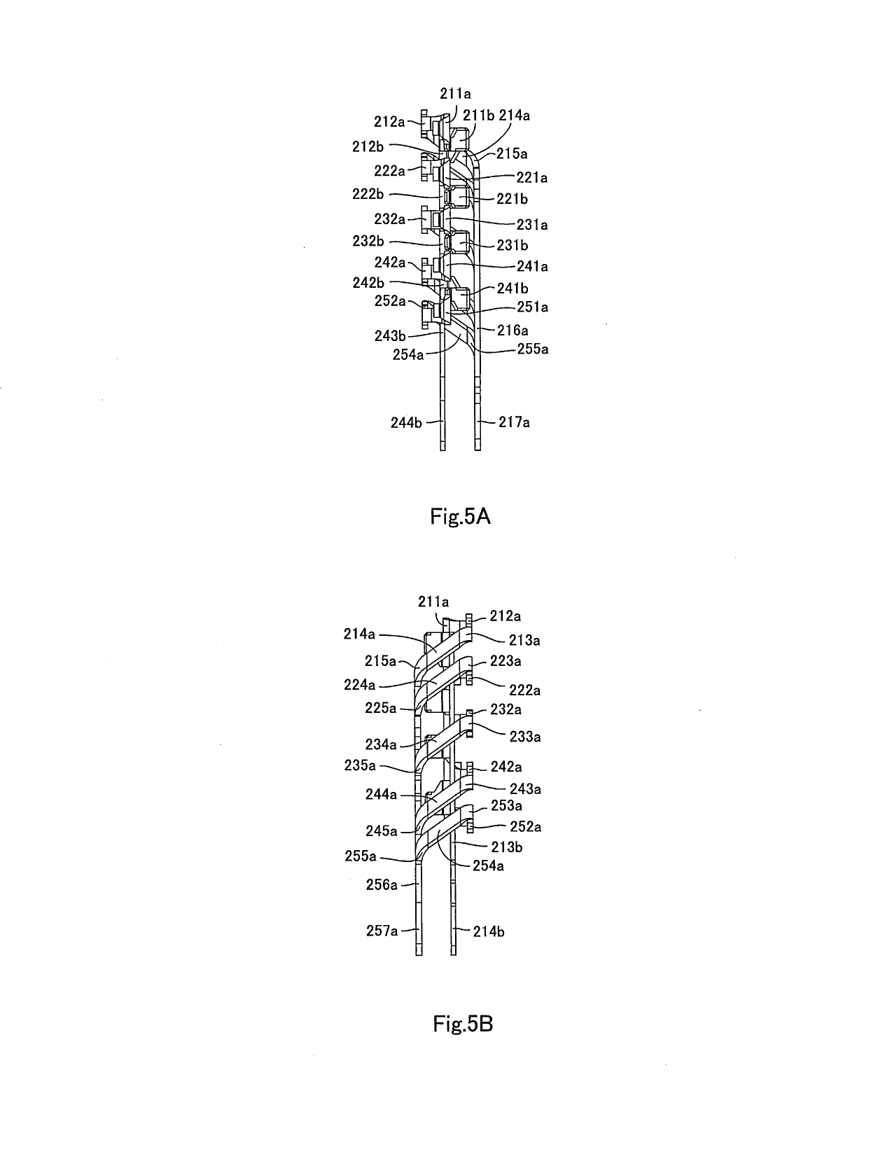

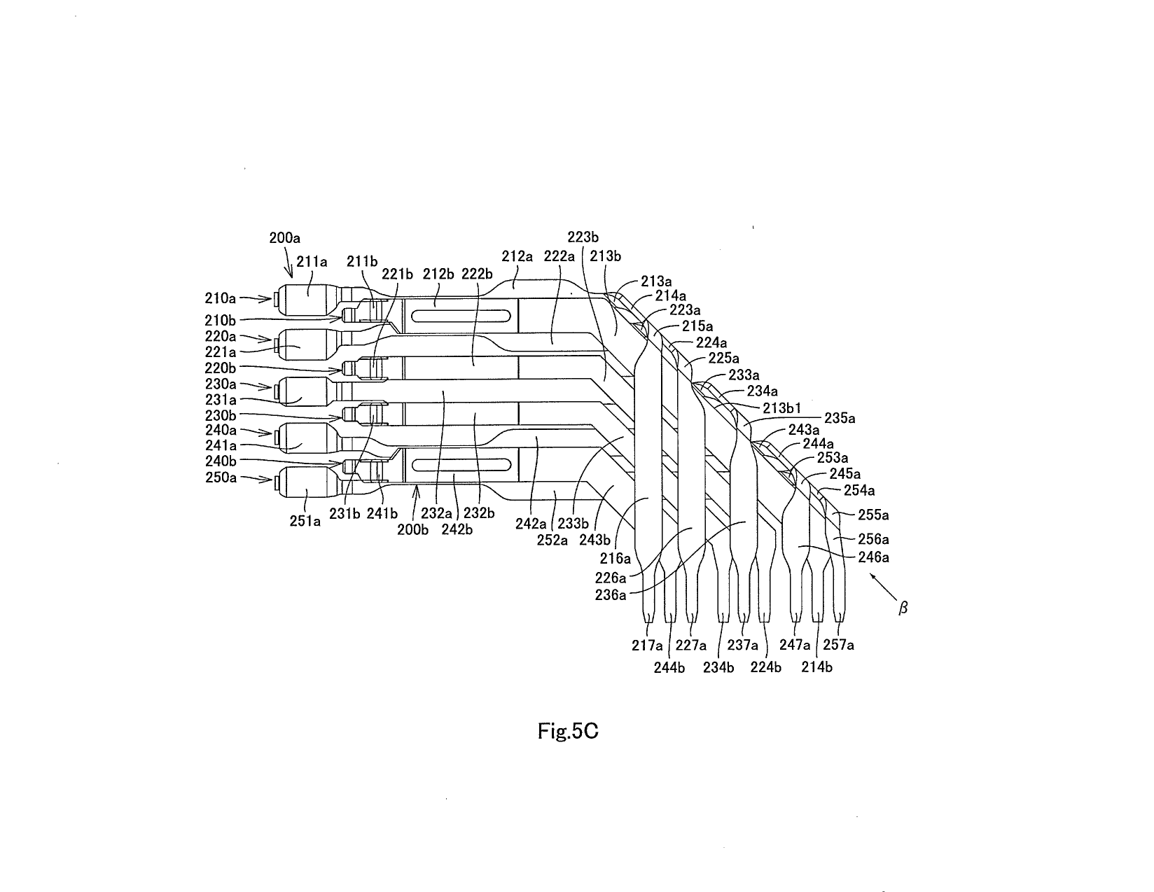

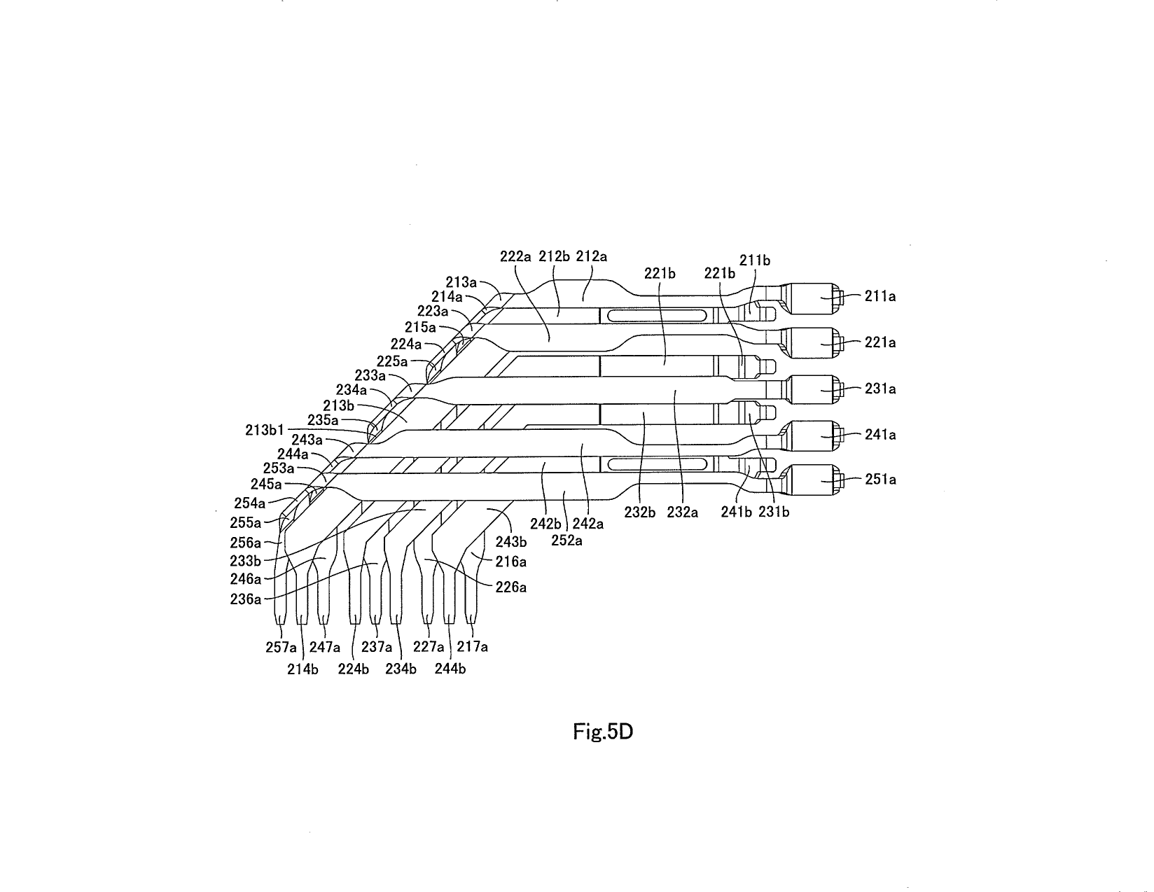

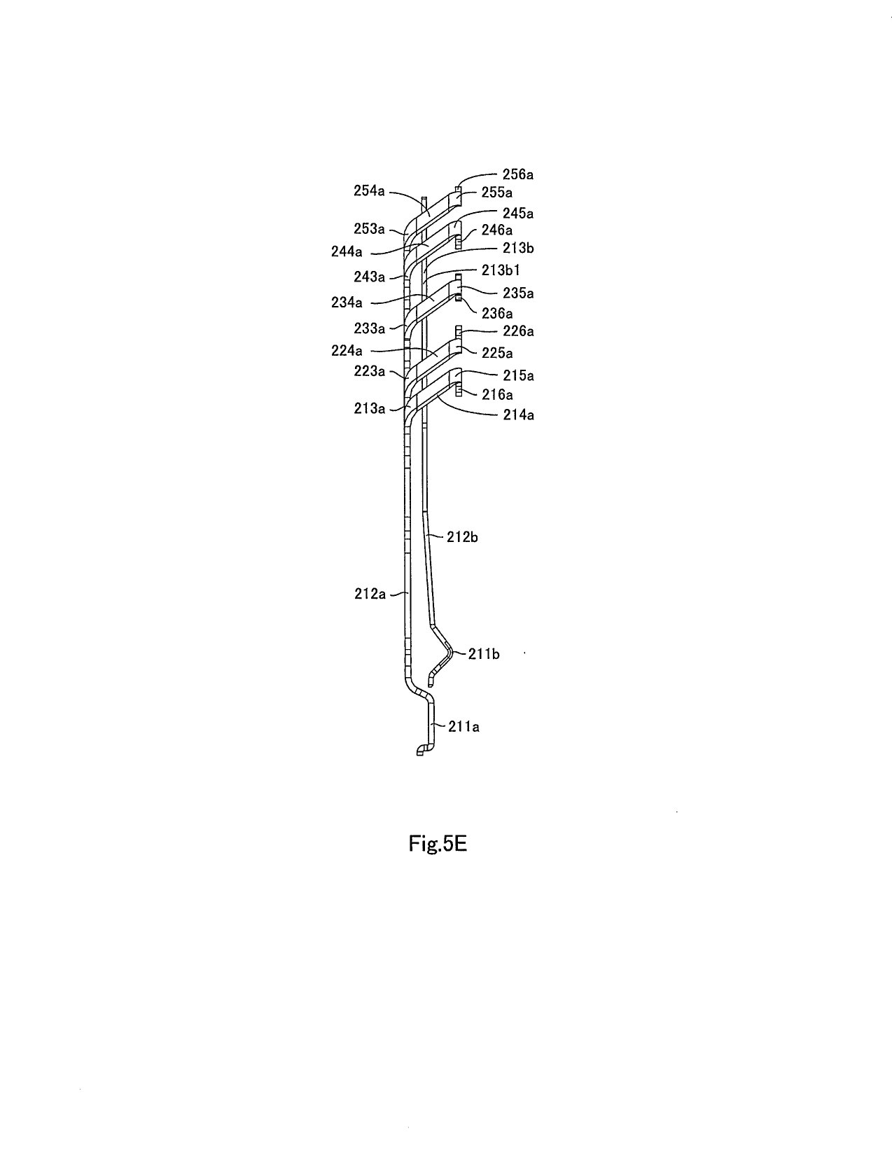

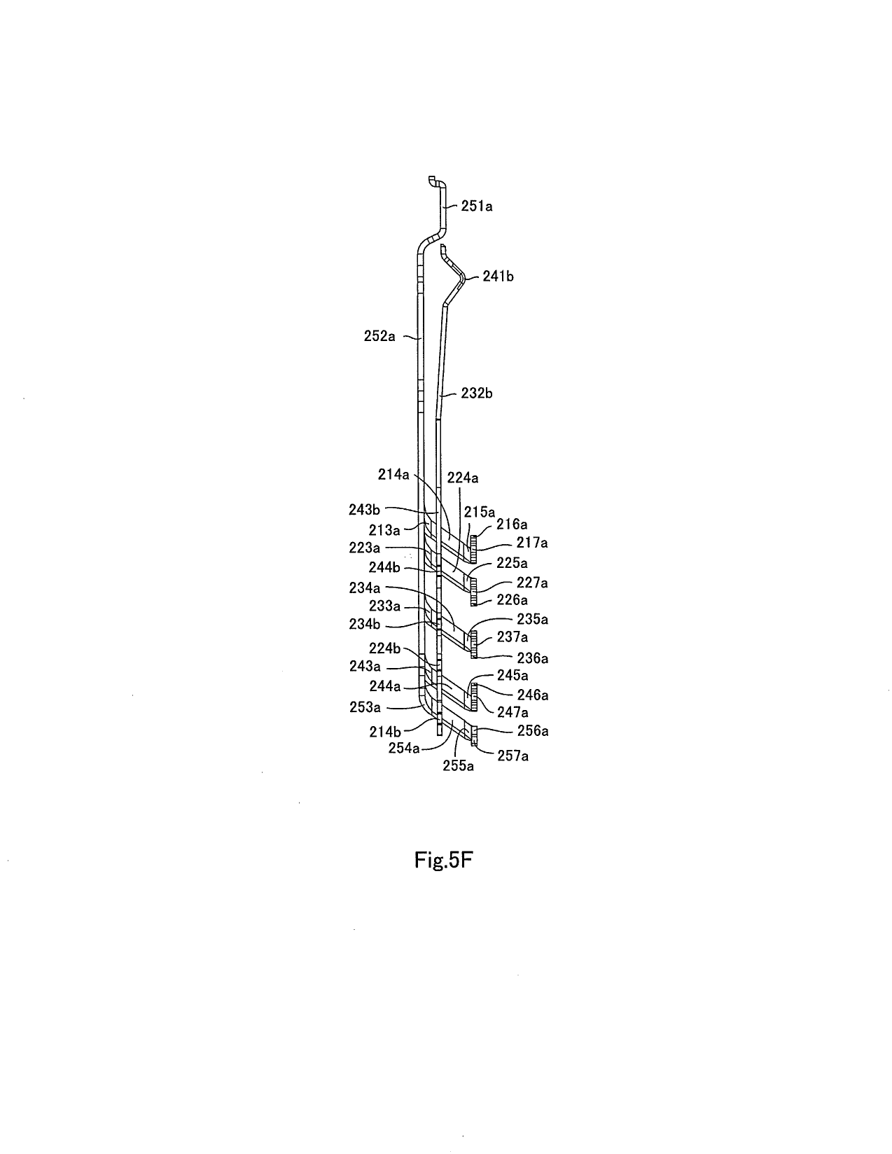

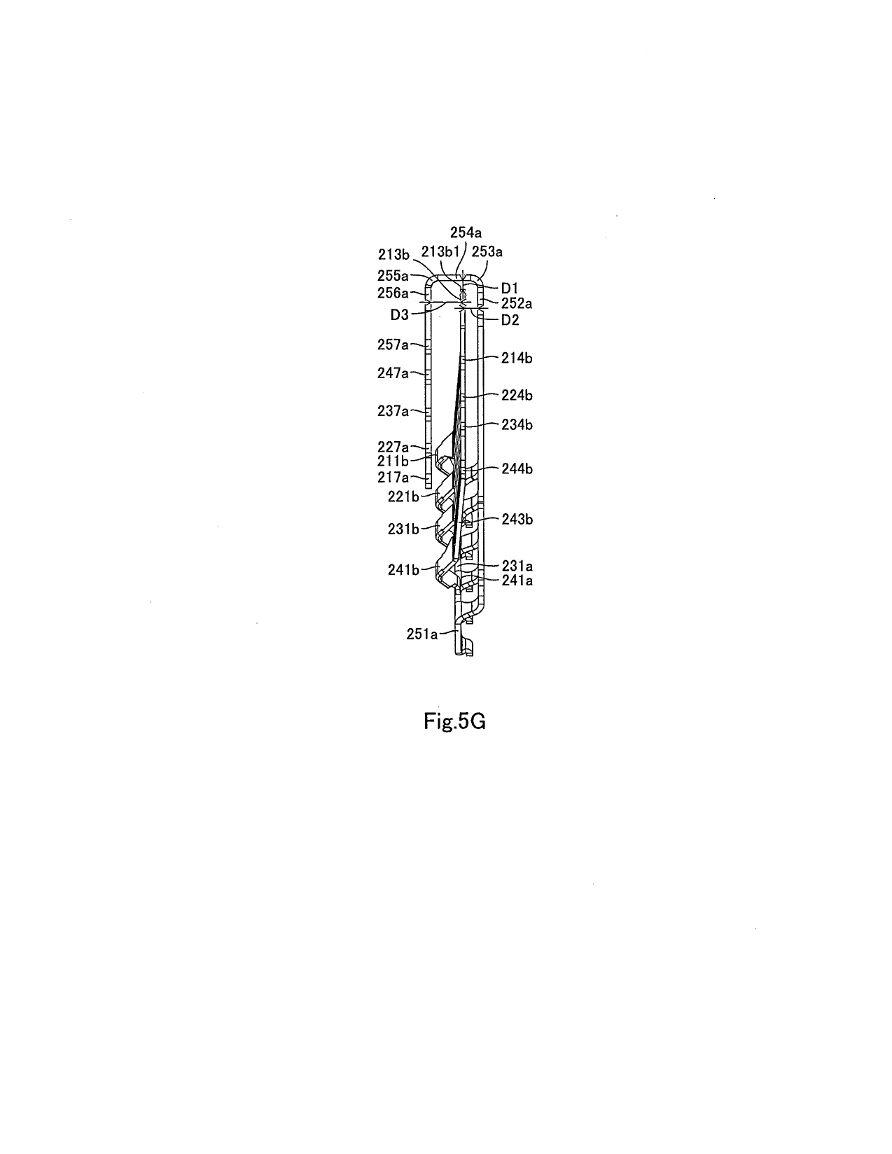

The first contact group 200a as shown in FIG. 5A to FIG. 5E may be compliant with USB 3.0 standard. The first contact group 200a consists of first and second contacts 210a, 220a, a fourth contact 230a, and first and second contacts 240a, 250a, each contact being formed of an electrically conductive metal plate. The first and second contacts 210a, 220a are TX+, TX− signal contacts constituting a first differential pair, and they are disposed adjacent to each other. The first and second contacts 210a, 220a are of substantially the same overall length. The first and second contacts 240a, 250a are RX+, RX− signal contacts constituting a second differential pair, and they are disposed adjacent to each other. The first and second contacts 240a, 250a are of substantially the same overall length. The fourth contact is a ground contact disposed between the first and second differential pairs (i.e. between the second contact 220a and the first contact 240a).

The first contact 210a has a contact portion 211a, a first straight portion 212a, a first bent portion 213a, an intermediate portion 214a, a second bent portion 215a, a second straight portion 216a, and a tail 217a. The second contact 220a has a contact portion 221a, a first straight portion 222a, a first bent portion 223a, an intermediate portion 224a, a second bent portion 225a, a second straight portion 226a, and a tail 227a. The fourth contact 230a has a contact portion 231a, a first straight portion 232a, a first bent portion 233a, an intermediate portion 234a, a second bent portion 235a, a second straight portion 236a, and a tail 237a. The first contact 240a has a contact portion 241a, a first straight portion 242a, a first bent portion 243a, an intermediate portion 244a, a second bent portion 245a, a second straight portion 246a, and a tail 247a. The second contact 250a has a contact portion 251a, a first straight portion 252a, a first bent portion 253a, an intermediate portion 254a, a second bent portion 255a, a second straight portion 256a, and a tail 257a.

As shown in FIG. 3A, the contact portions 211a, 221a, 231a, 241a, 251a are generally rectangular plates. They are embedded (fixed) in the distal portion 110a of the first body 100a, arrayed in this order at spaced intervals along the −Z direction, and exposed from the respective recesses 111a of the distal portion 110a.

The first straight portions 212a, 222a, 232a, 242a, 252a are long plates extending in the Y direction, provided continuously with the contact portions 211a, 221a, 231a, 241a, 251a, respectively. The first straight portion 222a has a larger length than the first straight portion 212a. The first straight portion 232a has a larger length than the first straight portion 222a. The first straight portion 242a has a larger length than the first straight portion 232a. The first straight portion 252a has a larger length than the first straight portion 242a. The first straight portions 212a, 222a, 232a, 242a, 252a are embedded (fixed) in the distal portion 110a and the proximal portion 120a of the first body 100a. As shown in FIG. 3A, the X direction faces of the first straight portions 212a, 222a, 232a, 242a, 252a are exposed from the X direction faces of the proximal portion 120a. The X direction faces of the first straight portions 212a, 222a, 232a, 242a, 252a are flush with the X direction face of the proximal portion 120a.

The first bent portions 213a, 223a, 233a, 243a, 253a are continuous with the first straight portions 212a, 222a, 232a, 242a, 252a, respectively, and they are all bent in a direction including components of X, Y, and −Z directions (i.e. a direction including components of the first, second, and third directions). The first bent portions 213a, 223a, 233a, 243a, 253a protrude in the Y direction from the sloped face of the proximal portion 120a (the sloped face of the first body 100a).

The intermediate portions 214a, 224a, 234a, 244a, 254a are straight plates continuous with the first bent portions 213a, 223a, 233a, 243a, 253a, respectively, and they all extend in the direction including components of the X, Y, and −Z directions (i.e. the direction including components of the first, second, and third directions). The second bent portions 215a, 225a, 235a, 245a, 255a are continuous with the intermediate portions 214a, 224a, 234a, 244a, 254a, respectively, and they are all bent in the −Z direction.

The second straight portions 216a, 226a, 236a, 246a, 256a are long plates continuous with the second bent portion 215a, 225a, 235a, 245a, 255a, respectively, and they all extend in the −Z direction. The second straight portion 226a has a smaller length than the second straight portion 216a by substantially the same amount as the difference in length between the first straight portion 222a and the first straight portion 212a. The second straight portion 236a has a smaller length than the second straight portion 226a by substantially the same amount as the difference in length between the first straight portion 232a and the first straight portion 222a. The second straight portion 246a has a smaller length than the second straight portion 236a by substantially the same amount as the difference in length between the first straight portion 242a and the first straight portion 232a. The second straight portion 256a has a smaller length than the second straight portion 246a by substantially the same amount as the difference in length between the first straight portion 252a and the first straight portion 242a. The second straight portions 216a, 226a, 236a, 246a, 256a are embedded in and extend through the second body 100b, more particularly, extending from the sloped face to the −Z direction face of the second body 100b. The second bent portion 215a, 225a, 235a, 245a, 255a protrude in the Y direction from the sloped face of the second body 100b. That is, the first bent portions 213a, 223a, 233a, 243a, 253a, the intermediate portions 214a, 224a, 234a, 244a, 254a, and the second bent portions 215a, 225a, 235a, 245a, 255a are located outside the first and second bodies 100a, 100b.

The first straight portions 212a, 222a, 232a, 242a, 252a are partially opposed to the second straight portions 216a, 226a, 236a, 246a, 256a, respectively. As shown in FIG. 3A and FIG. 3B, the second body 100b with the second straight portions 216a, 226a, 236a, 246a, 256a embedded therein is opposed to the proximal portion 120a of the first body 100a. The region defined between the first and second bodies 100a, 100b (i.e., the region between the first straight portions 212a, 222a, 232a, 242a, 252a and the second straight portions 216a, 226a, 236a, 246a, 256a) will be used for disposing the second contact group 200b.

The tails 217a, 227a, 237a, 247a, 257a are plates continuous with the second straight portions 216a, 226a, 236a, 246a, 256a, respectively, and they all extend in the −Z direction. The tails 217a, 227a, 237a, 247a, 257a are arrayed in this order at spaced intervals in a row along the Y direction. The tails 217a, 227a, 237a, 247a, 257a are connectable to respective first through hole electrodes in the circuit board.

The first and second contacts 210a, 220a are arranged such that an equal distance is maintained between the first straight portions 212a, 222a, between the first bent portions 213a, 223a, between the intermediate portions 214a, 224a, between the second bent portions 215a, 225a, and between the second straight portions 216a, 226a. Similarly, the first and second contacts 240a, 250a are arranged such that an equal distance is maintained between the first straight portions 242a, 252a, between the first bent portions 243a, 253a, between the intermediate portions 244a, 254a, between the second bent portions 245a, 255a, and between the second straight portions 246a, 256a.

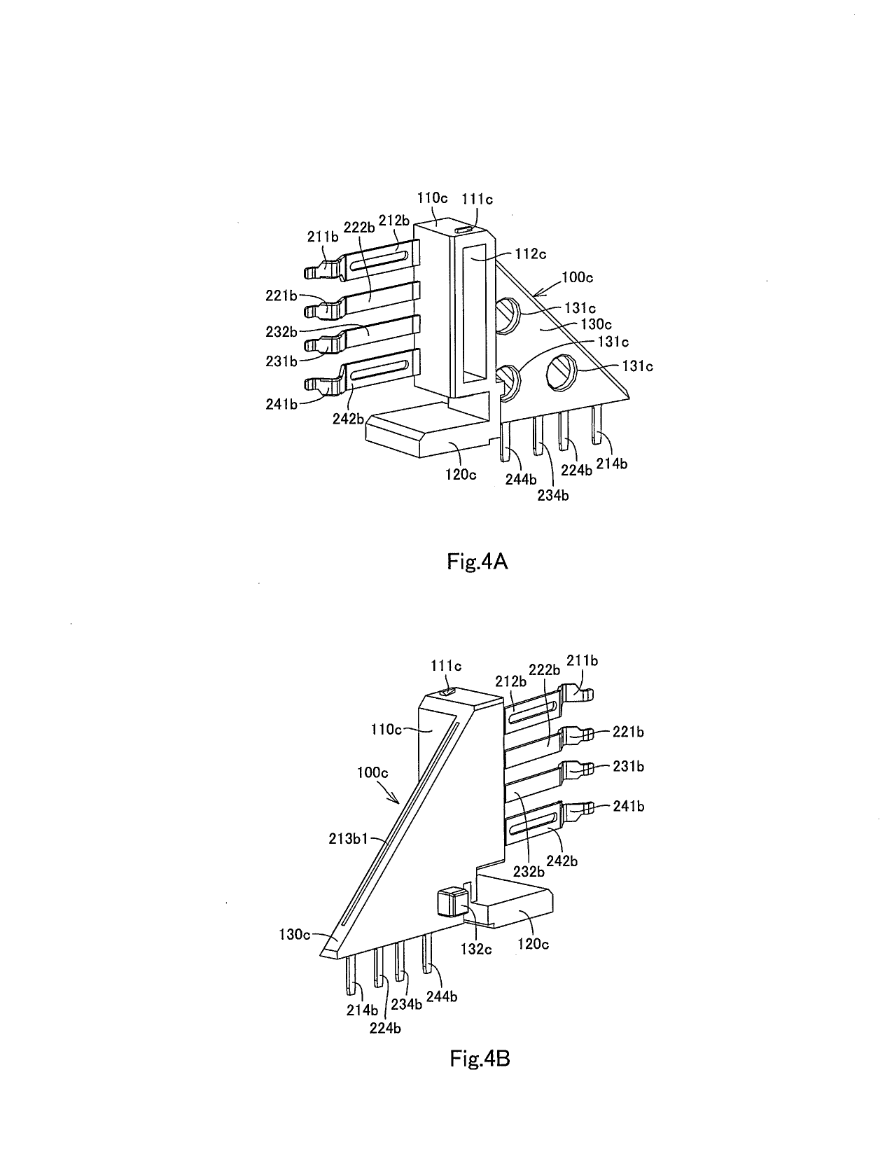

As shown in FIG. 4A and FIG. 4B, the third body 100c includes a block 110c, a tongue 120c, and a plate 130c. The plate 130c is a plate generally of right-angled triangle shape, provided continuous with the block 110c and the tongue 120c. The plate 130c has a substantially equal dimension in the X and −X directions to the distance between the proximal portion 120a of the first body 100a and the second body 100b. The plate 130c is securely held between the proximal portion 120a of the first body 100a and the second body 100b. The X direction face of the plate 130c has fitting recesses 131c at positions corresponding to the fitting protrusions 120b of the second body 100b. The −X direction face of the plate 130c has a rectangular fitting protrusion 132c. When the plate 130c is held between the proximal portion 120a of the first body 100a and the second body 100b, the fitting protrusions 120b are fittingly engaged in the fitting recesses 131c, and the fitting protrusion 132c is fittingly engaged in the fitting hole 124a of the first body 100a. The hypotenuse side of the plate 130c has a sloped face.

The block 110c is a rectangular parallelepiped extending in the Z and −Z directions. The dimension in the Z and −Z directions of the block 110c is substantially equal to the distance between the arms 130a of the first body 100a. The block 110c fits in the accommodation space a of the first body 100a. The ends in the Z and −Z directions of the block 110c are provided with locking claws 111c (one of the claws is shown). The locking claws 111c are engaged with the locking holes 131a of the arms 130a of the first body 100a. The X direction face of the block 110c has a rectangular locking hole 112c. The tongue 120c is a generally L-shaped plate continuous with the −Z direction end of the block 110c. The L-shaped tongue 120c has a first portion on the Z direction side and a second portion on the −Z direction side oriented orthogonal to the first portion. The distance between the second portion of the tongue 120c and the block 110c is larger than the dimension in the Z and −Z directions of the arm 130a on the −Z direction side of the first body 100a. As shown in FIG. 2A, this arm 130a is disposed between the second portion of the tongue 120c and the block 110c, leaving a gap between the second portion of the tongue 120c and the arm 130a. The Y direction face of the second portion of the tongue 120c has an locking protrusion 121c as shown in FIG. 1D. When the plate 130c is held between the proximal portion 120a of the first body 100a and the second body 100b, the locking protrusion 121c is locked against the locking protrusion 110b of the second body 100b.

The second contact group 200b as shown in FIG. 5A to FIG. 5E may be compliant with USB 2.0 standard. The second contact group 200b consists of generally L-shaped third contacts 210b, 220b, 230b, 240b, each formed of an electrically conductive metal plate. The third contacts 210b, 220b, 230b, 240b are held in the third body 100c and arrayed in this order at spaced intervals along the −Z direction. The third contact 210b is a Vbus contact. The third contacts 220b, 230b are Data−, Data+ contacts constituting a differential pair, and they are disposed adjacent to each other. The third contact 240b is a GND contact.

The third contact 210b has a contact portion 211b, a straight portion 212b, an inclined portion 213b, and a tail 214b. The third contact 220b has a contact portion 221b, a straight portion 222b, an inclined portion 223b, and a tail 224b. The third contact 230b has a contact portion 231b, a straight portion 232b, an inclined portion 233b, and a tail 234b. The third contact 240b has a contact portion 241b, a straight portion 242b, an inclined portion 243b, and a tail 244b.

The contact portions 211b, 221b, 231b, 241b are plates of generally V-shapes with apexes pointing in the X direction. The straight portions 212b, 222b, 232b, 242b are elongated plates continuous with the contact portions 211b, 221b, 231b, 241b, respectively, and they all extend in the Y direction. The inclined portions 213b, 223b, 233b, 243b are elongated plates continuous with the straight portions 212b, 222b, 232b, 242b, respectively, and they all extend obliquely in the Y and −Z directions. The inclined portion 213b has a larger length than the inclined portion 223b. The inclined portion 223b has a larger length than the inclined portion 233b. The inclined portion 233b has a larger length than the inclined portion 243b. The tail 214b, 224b, 234b, 244b are plates continuous with the inclined portion 213b, 223b, 233b, 243b, respectively, and they all extend in the −Z direction.

As shown in FIG. 4A, the inclined portions 213b, 223b, 233b, 243b are embedded (fixed) in the plate 130c of the third body 100c and arrayed in this order at spaced intervals along the −Z direction. The Y direction ends of the straight portions 212b, 222b, 232b, 242b are embedded in the block 110c of the third body 100c and arrayed in this order at spaced intervals along the −Z direction. As shown in FIG. 4B, the inclined portion 213b as embedded has an inclined face 213b1 in the Z direction exposed from the sloped face of the plate 130c. The portions other than the Y direction ends of the straight portions 212b, 222b, 232b, 242b project in the −Y direction out of the block 110c. The contact portions 211b, 221b, 231b, 241b are arrayed in this order at spaced intervals along the −Z direction. The tails 244b, 254b, 234b, 214b are arrayed in this order at spaced intervals along the Y direction. The tails 244b, 254b, 234b, 214b are connectable with respective second through-hole electrodes in the circuit board. The lengths of the inclined portions 213b, 223b, 233b, 243b are determined such that the distal ends of the tails 244b, 254b, 234b, 214b are flush with each other.

When the block 110c fits in the accommodation space α of the first body 100a and the plate 130c is held between the proximal portion 120a of the first body 100a and the second body 100b, the third contacts 210b, 220b, 230b, 240b are located in the region between the first straight portions 212a, 222a, 232a, 242a, 252a and the second straight portions 216a, 226a, 236a, 246a, 256a of the first contact group 200a, substantially in parallel to the first straight portions 212a, 222a, 232a, 242a, 252a. In this state, the portions other than the Y direction ends of the straight portions 212b, 222b, 232b, 242b and the contact portions 211b, 221b, 231b, 241b are received in the respective grooves 112a of the first body 100a, and the straight portions 212b, 222b, 232b, 242b are each held between the Z direction wall and the −Z direction wall of the associated groove 112a and elastically deformable in the −X direction (toward the first contact group). In this state, the straight portion 212b is disposed in a space between and on the X direction side of the first straight portions 212a, 222a; the straight portion 222b is disposed in a space between and on the X direction side of the first straight portions 222a, 232a; the straight portion 232b is disposed in a space between and on the X direction side of the first straight portions 232a, 242a; and the straight portion 242b is disposed in a space between and on the X direction side of the first straight portions 242a, 252a. The contact portions 211b, 221b, 231b, 241b are located in midair in the grooves 112a such that they are displaceable in the −X direction in accordance with the elastic deformation of the straight portions 212b, 222b, 232b, 242b. The inclined portions 213b, 223b, 233b, 243b are located between the first straight portions 212a, 222a, 232a, 242a, 252a and the second straight portions 216a, 226a, 236a, 246a, 256a, respectively. The tails 244b, 234b, 224b, 214b and the tails 217a, 227a, 237a, 247a, 257a are arranged in a staggered configuration.

The inclined portion 213b is located in the vicinity of the first bent portions 213a, 223a, 243a, 253a, the intermediate portion 214a, 224a, 244a, 254a, and the second bent portion 215a, 225a, 245a, 255a. The inclined face 213b1 of the inclined portion 213b of the third contact 210b, which is exposed from the sloped face of the plate 130c, is disposed substantially in parallel to the intermediate portion 214a, 224a, 234a, 244a, 254a of the first, second and fourth contacts 210a, 220a, 230a, 240a, 250a as shown in FIG. 5C, FIG. 5D and FIG. 5G. The first bent portions 213a, 223a, 243a, 253a, the intermediate portions 214a, 224a, 244a, 254a, and the second bent portions 215a, 225a, 245a, 255a as exposed from the first and second bodies 100a, 100b should have higher impedances than the other portions of the first and second contacts 210a, 220a, 240a, 250a. However, the above mentioned disposition of the inclined face 213b1 contributes to reduction in impedance of the first bent portions 213a, 223a, 243a, 253a, the intermediate portions 214a, 224a, 244a, 254a, and the second bent portions 215a, 225a, 245a, 255a. It should be appreciated that the first, second, third bodies 100a, 100b, 100c are not illustrated in FIG. 5G for convenience of description.

FIG. 5G indicates distances D1, D2, and D3, where D1 is the distance between the inclined portion 213b and the intermediate portions 214a, 224a, 234a, 244a, 254a; D2 is the distance between the inclined portion 213b and the first straight portions 212a, 222a, 232a, 242a, 252a; and D3 is the distance between the inclined portion 213b and the second straight portions 216a, 226a, 236a, 246a, 256a. The distances D1, D2, and D3 are adjusted in accordance with a difference between impedances I1 and I2, where I1 is each impedance of the first bent portions 213a, 223a, 243a, 253a, the intermediate portions 214a, 224a, 244a, 254a, and the second bent portion 215a, 225a, 245a, 255a of the first and second contacts 210a, 220a, 240a, 250a; I2 is a reference impedance required of the present connector, which may be 90Ω to 100Ω. For example, if the impedance I1 is higher than the reference impedance I2 in the case where D1 is approximately equal to D2 or to D3, the distances D1, D2, and D3 are adjusted such that D1 becomes smaller than D2 and than D3. If the impedance I1 is lower than the reference impedance I2 in the case where D1 is approximately equal to D2 or to D3, the distances D1, D2, and D3 are adjusted such that D1 becomes larger than D2 and than D3. FIG. 5G illustrates a case where D1 is smaller than D2 and than D3.

The shell 300 is formed of an electrically conductive metal plate. As shown in FIG. 1A to FIG. 1D, the shell 300 has a square tube 310, a pair of extended portions 320, a back cover 330, a pair of locking portions 340, a pair of first legs 350, and a second leg 360.

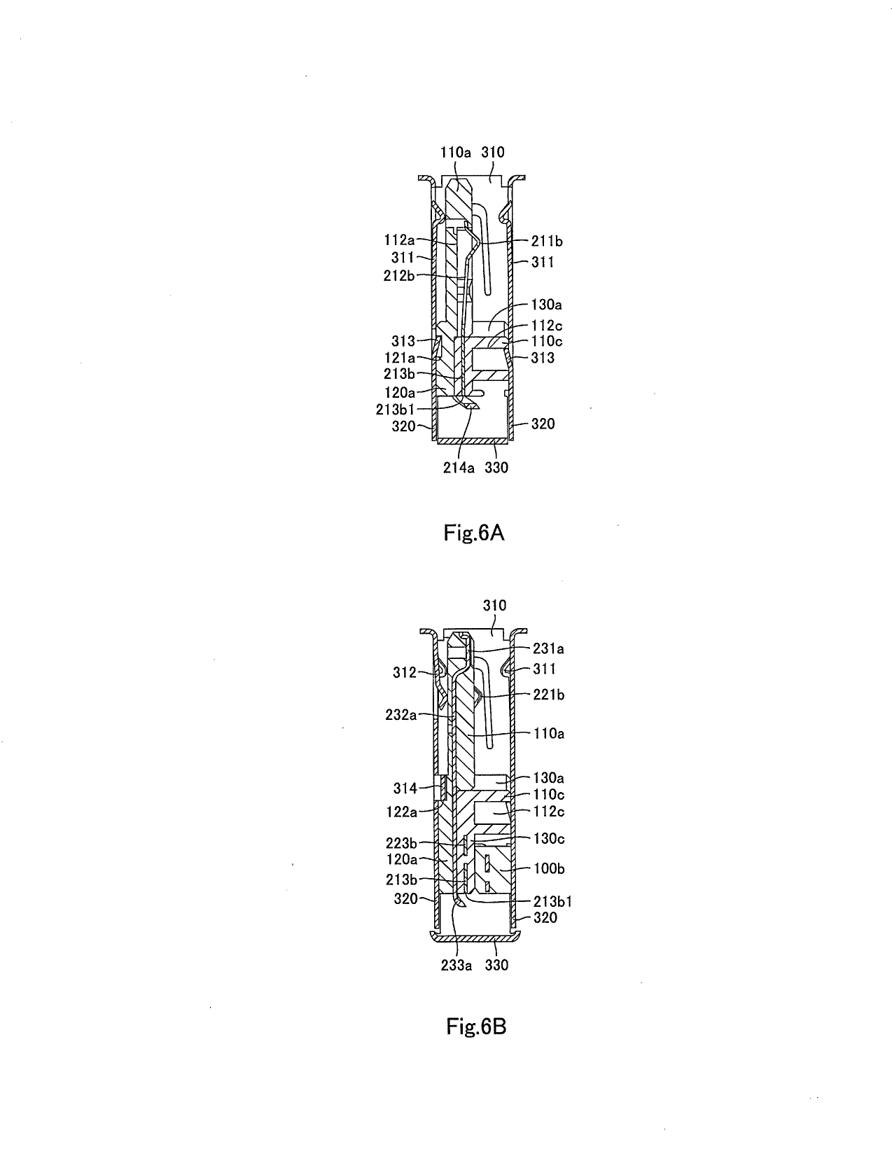

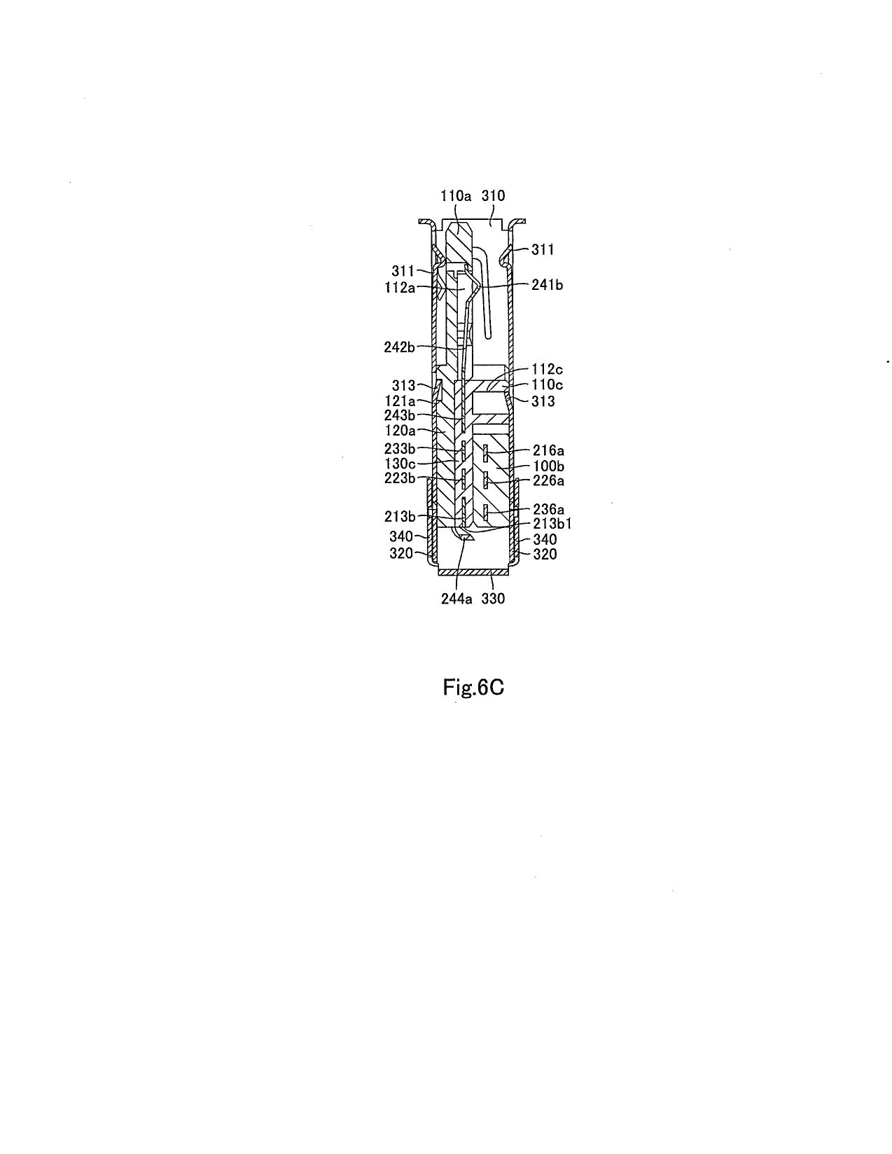

The square tube 310 consists of four plates, namely on the X, −X, Z, and −Z sides. As shown in FIG. 6A to FIG. 6C, the square tube 310 covers the distal portion 110a, the −Y direction end of the proximal portion 120a, and the pair of arms 130a the first body 100a, and the block 110c of the third body 100c. The X direction side plate of the square tube 310 is in contact with the block 110c, the −X direction side plate is in contact with the −Y direction end of the proximal portion 120a, and the Z direction side plate is in contact with the arm 130a on the Z direction side. The −Z direction side plate of the square tube 310 is received in the gap between this arm 130a and the second portion of the tongue 120c of the third body 100c as shown in FIG. 1C. The square tube 310, the distal portion 110a, the pair of arms 130a, and the block 110c define a slot for receiving a mating connector (e.g. USB 2.0 plug or USB 3.0 plug).

The −X direction side plate of the square tube 310 has a pair of first locking pieces 311, a second locking piece 312, a pair of third locking pieces 313, and a step-down 314. The X direction side plate of the square tube 310 has a pair of first locking pieces 311 and a pair of third locking pieces 313. The Z direction side plate of the square tube 310 has a first locking piece 311. The first locking pieces 311, five in all, are each formed by cutting a part of the −Y direction end of the plate, and they extend in the −Y direction. The second locking piece 312 is formed by cutting a portion between the locking pieces 311 at the −Y direction end of the −X direction side plate, and it extends in the Y direction. The first and second locking pieces 311, 312 are adapted to be locked in recesses of a mating connector received in the slot. The pairs of third locking pieces 313 are tabs formed by partially cutting the Y direction ends of the X and −X direction side plates and bending them in the −X and X directions, respectively. As shown in FIG. 6A, the step-down 314 is a projection inwardly projecting generally in U-shape, produced by bending in the X direction a portion between the third locking pieces 313 of the −Y direction end of the −X direction side plate. As shown in FIG. 6A, the third locking pieces 313 of the X direction side plate are locked in the locking hole 112c of the third body 100c. The third locking pieces 313 of the −X direction side plate are locked in the locking holes 121a of the first body 100a. As shown in FIG. 6B, the step-down 314 is locked in the locking recess 122a of the first body 100a.

The extended portions 320 are plates generally of right-triangle shape provided continuously with the Y direction ends of the X and −X direction side plates of the square tube 310. The space between the extended portions 320 accommodates the portion other than the −Y direction end of the proximal portion 120a of the first body 100a, the second body 100b, and the plate 130c of the third body 100c. The extended portion 320 on the −X direction side is in contact with the portion other than the −Y direction end of the proximal portion 120a of the first body 100a, and the extended portion 320 on the X direction side is in contact with the second body 100b. Between the hypotenuse sides of the extended portions 320 is formed an open portion. A protrusion 321 projects outward in the vicinity of the hypotenuse side of each extended portion 320.

The back cover 330 is a rectangular plate continuous with the Y direction end of the Z direction side plate of the square tube 310. The back cover 330 closes the open portion of the extended portions 320. In this state, the back cover 330 is located in the vicinity of and in spaced relation to the first bent portions 213a, 223a, 243a, 253a, the intermediate portions 214a, 224a, 244a, 254a, and the second bent portions 215a, 225a, 245a, 255a of the first, second and fourth contacts 210a, 220a, 230a, 240a, 250a. The back cover 330 extends substantially in parallel to the intermediate portions 214a, 224a, 234a, 244a, 254a of the first, second and fourth contacts 210a, 220a, 230a, 240a, 250a. This disposition of the back cover 330 contributes to reduction in impedance of the first bent portions 213a, 223a, 243a, 253a, the intermediate portions 214a, 224a, 244a, 254a, and the second bent portions 215a, 225a, 245a, 255a. That is, the back cover 330 functions as an impedance adjusting portion for adjusting the impedances of the first bent portions 213a, 223a, 243a, 253a, the intermediate portions 214a, 224a, 244a, 254a, and the second bent portions 215a, 225a, 245a, 255a.

The locking portions 340 are rectangular plates continuous with the X and −X direction ends of the back cover 330 and are bent at a substantially right angle to the back cover 330. The locking portions 340 each have a notch 341. The locking portions 340 are in contact with outer faces of the extended portions 320, and the protrusions 321 of the extended portions 320 are locked in the notches 341 of the locking portions 340. This locking mechanism maintains the state where the back cover 330 closes the open portion.

The first legs 350 are continuous with the extended portions 320 and extend in the −Z direction. The second leg 360 is continuous with the back cover 330 and extends in the −Z direction. The first and second legs 350, 360 are connectable with third through-hole electrodes in the circuit board. The shell 300 is grounded by connecting the first and second legs 350, 360 to the third through-hole electrodes of the circuit board.

The connector described above may be fabricated in the following steps. The first step is to prepare the first, second and fourth contacts 210a, 220a, 230a, 240a, 250a. The first, second and fourth contacts 210a, 220a, 230a, 240a, 250a are yet to be bent at the first bent portions 213a, 223a, 243a, 253a and the second bent portions 215a, 225a, 245a, 255 at (i.e. the first straight portions 212a, 222a, 232a, 242a, 252a and the second straight portions 216a, 226a, 236a, 246a, 256a extend in straight lines).

The first, second and fourth contacts 210a, 220a, 230a, 240a, 250a are inserted into dies, into which insulating resin is poured to form the first and second bodies 100a, 100b with the first, second and fourth contacts 210a, 220a, 230a, 240a, 250a inserted therein. Then, the contact portions 211a, 221a, 231a, 241a, 251a of the first, second and fourth contacts 210a, 220a, 230a, 240a, 250a are embedded in the first body 100a to be arrayed in this order at spaced intervals along the −Z direction, and the first straight portions 212a, 222a, 232a, 242a, 252a of the first, second and fourth contacts 210a, 220a, 230a, 240a, 250a are embedded in the first body 100a to be arrayed in this order at spaced intervals along the −Z direction. The contact portions 211a, 221a, 231a, 241a, 251a are exposed from the recesses 111a of the distal portion 110a of the first body 100a. The X direction faces of the first straight portion 212a, 222a, 232a, 242a, 252a are exposed from the X direction face of the proximal portion 120a of the first body 100a. On the other hand, the second straight portion 216a, 226a, 236a, 246a, 256a of the first, second and fourth contacts 210a, 220a, 230a, 240a, 250a are embedded in the second body 100b so as to extend through the second body 100b, particularly from the sloped face thereof to the −Z direction end face thereof. The tails 217a, 227a, 237a, 247a, 257a of the first, second and fourth contacts 210a, 220a, 230a, 240a, 250a are arranged in this order in a row. The first bent portions 213a, 223a, 233a, 243a, 253a, the intermediate portions 214a, 224a, 234a, 244a, 254a, and the second bent portions 215a, 225a, 235a, 245a, 255a of the first, second and fourth contacts 210a, 220a, 230a, 240a, 250a protrude out of between the first and second bodies 100a, 100b.

After insert molding the contacts in the first and second bodies 100a, 100b, the first and second contacts 210a, 220a are situated in such a manner as to substantially equalize the distances between the first straight portions 212a, 222a, between the first bent portions 213a, 223a, between the intermediate portions 214a, 224a, between the second bent portions 215a, 225a, and between the second straight portions 216a, 226a. Also, the first and second contacts 240a, 250a are situated in such a manner as to substantially equalize the distances between the first straight portions 242a, 252a, between the first bent portions 243a, 253a, between the intermediate portions 244a, 254a, between the second bent portions 245a, 255a, and between the second straight portions 246a, 256a.

In the meantime, the third contacts 210b, 220b, 230b, 240b are also prepared. The third contacts 210b, 220b, 230b, 240b are inserted into dies, into which insulating resin is poured to form the third body 100c with the third contacts 210b, 220b, 230b, 240b inserted therein. Then, the inclined portions 213b, 223b, 233b, 243b of the third contacts 210b, 220b, 230b, 240b are embedded in the third body 100c to be arrayed in this order at spaced intervals along the −Z direction. The Y direction ends of the straight portions 212b, 222b, 232b, 242b of the third contacts 210b, 220b, 230b, 240b are embedded in the third body 100c to be arrayed in this order at spaced intervals along the −Z direction, while the portions other than the Y direction ends of the straight portions 212b, 222b, 232b, 242b protrude in the −Y direction out of the third body 100c. The tails 244b, 254b, 234b, 214b of the third contacts 210b, 220b, 230b, 240b protrude in the −Z direction out of the third body 100c and are arrayed in this order at spaced intervals along the Y direction. The inclined face 213b1 of the inclined portion 213b of the third contact 210b is exposed from the sloped face of the third body 100c (sloped face of the plate 130c).

The next step is to insert the contact portions 211b, 221b, 231b, 241b of the third contacts 210b, 220b, 230b, 240b and the portions other than the Y direction ends of the straight portions 212b, 222b, 232b, 242b into the grooves 112a of the distal portion 110a of the first body 100a. Then, the straight portions 212b, 222b, 232b, 242b are each held between the Z direction wall and the −Z direction wall of the associated groove 112a of the distal portion 110a. As inserted, the straight portion 212b is located in the space between and on the X direction side of the first straight portions 212a, 222a of the first and second contacts 210a, 220a; the straight portion 222b is located in the space between and on the X direction side of the first straight portions 222a, 232a of the second and fourth contacts 220a, 230a; the straight portion 232b is located in the space between and on the X direction side of the first straight portions 232a, 242a of the fourth and first contacts 230a, 240a; and the straight portion 242b is located in the space between and on the X direction side of the first straight portions 242a, 252a of the first and second contacts 240a, 250a.

Simultaneously, the block 110c of the third body 100c is fittingly put into the accommodation space a, of the first body 100a, and the plate 130c of the third body 100c is brought into contact with the proximal portion 120a of the first body 100a. Then, the locking claws 111c of the block 110c are locked in the locking holes 131a of the arms 130a of the first body 100a. The fitting protrusion 132c of the plate 130c is fittingly put into the fitting hole 124a of the proximal portion 120a. The third body 100c is thus combined with the first body 100a.

The next step is to bend the first bent portions 213a, 223a, 233a, 243a, 253a of the first, second and fourth contacts 210a, 220a, 230a, 240a, 250a in the direction including components of X, Y, and −Z directions. Then, the intermediate portions 214a, 224a, 234a, 244a, 254a are oriented in the same direction (the direction including the components of X, Y, and −Z directions). After that, the second bent portions 215a, 225a, 235a, 245a, 255a are bent in the −Z direction. Then, the second straight portions 216a, 226a, 236a, 246a, 256a are oriented in the −Z direction, and the second body 100b is brought into contact with the third body 100c. As a result, the plate 130c of the third body 100c is held between the proximal portion 120a of the first body 100a and the second body 100b. At this point, the fitting protrusions 120b of the second body 100b fit into the fitting recesses 131c of the third body 100c, and the locking protrusion 121c of the tongue 120c of the third body 100c is locked against the locking protrusion 110b of the second body 100b. The tails 217a, 244b, 227a, 234b, 237a, 224b, 247a, 214b, 257a are arrayed along the Y direction in this order in a staggered manner. The first bent portions 213a, 223a, 233a, 243a, 253a, the intermediate portions 214a, 224a, 234a, 244a, 254a, and the second bent portions 215a, 225a, 235a, 245a, 255a are arranged on the Y direction side of the sloped faces of the first, second, and third bodies 100a, 100b, 100c. The inclined face 213b1 of the inclined portion 213b of the third contact 210b, which is exposed from the sloped face of the third body 100c, is disposed in the vicinity of and in spaced relation to the intermediate portions 214a, 224a, 234a, 244a, 254a. It should be appreciated that the distances D1, D2, and D3 are determined in such a manner as to substantially equalize the impedances of the first bent portions 213a, 223a, 243a, 253a, the intermediate portions 214a, 224a, 244a, 254a, and the second bent portions 215a, 225a, 245a, 255a of the first and second contacts 210a, 220a, 240a, 250a to the impedances of the remaining portions of the first and second contacts 210a, 220a, 240a, 250a. The first, second, and third bodies 100a, 100b, 100c are thus combined with one another.

The next step is to prepare the shell 300 by press-molding a meal plate. The shell 300 is in a state that the back cover 330 is oriented in flush with the Z direction side plate of the square tube 310, and the locking portions 340 are oriented in flush with the back cover 330. That is, the back cover 330 is not closing the open portion between the extended portions 320 at this point. In this state, the first, second, third bodies 100a, 100b, 100c are inserted into the shell 300 through the open portion. Then, the distal portion 110a, the −Y direction end of the proximal portion 120a, and the pair of arms 130a of the first body 100a, as well as the block 110c of the third body 100c are accommodated in the square tube 310 of the shell 300, and the other portion than the −Y direction end of the proximal portion 120a of the first body 100a, the second body 100b, and the plate 130c of the third body 100c are accommodated between the extended portions 320. At this point, the X direction side plate of the square tube 310 comes into contact with the block 110c; the −X direction side plate thereof comes into contact with the −Y direction end of the proximal portion 120a; and the Z direction side plate thereof comes into contact with the arm 130a on the Z direction side; the −Z direction side plate of the square tube 310 is inserted into the gap between the other arm 130a and the second portion of the tongue 120c of the third body 100c. Simultaneously, the extended portion 320 on the X direction side comes into contact with the second body 100b, and the extended portion 320 on the −X direction side comes into contact with the portion other than the −Y direction end of the proximal portion 120a of the first body 100a. The third locking pieces 313 of The X direction side plate are locked in the locking hole 112c of the third body 100c, the third locking pieces 313 of the −X direction side plate are locked in the locking holes 121a of the first body 100a, and the step-down 314 is locked in the locking recess 122a of the first body 100a.

The next step is to bend the boundary between the back cover 330 and the Z direction side plate of the square tube 310 in the −Z direction, thereby causing the back cover 330 to close the open portion. After that, the pair of locking portions 340 of the shell 300 is bent to come into contact with the extended portions 320 of the shell 300. Then, the protrusions 321 of the extended portions 320 are locked in the notches 341 of the locking portions 340.

The connector is thus assembled and now ready to be mounted on a circuit board. Specifically, the first and second legs 350, 360 of the shell 300 are inserted into and connected to the associated third-through hole electrodes in the circuit board. The tails 217a, 244b, 227a, 234b, 237a, 224b, 247a, 214b, 257a are also inserted into and connected to the associated first and second through-hole electrodes in the circuit board.

The components of the connector may operate in the following manner when connected to a mating connector, which may be a plug connector compliant with USB 2.0 or 3.0 standard (hereinafter referred to as “USB 2.0 plug” and “USB 3.0 plug”). When a USB 2.0 plug is inserted into the slot of the connector, the contacts of the USB 2.0 plug come into contact with the contact portions 211b, 221b, 231b, 241b of the third contacts 210b, 220b, 230b, 240b. Then, the straight portions 212b, 222b, 232b, 242b of the third contacts 210b, 220b, 230b, 240b elastically deform in the −X direction, and the contact portions 211b, 221b, 231b, 241b are displaced inside the grooves 112a in the −X direction. Then, the first and second locking pieces 311, 312 of the shell 300 are locked in recesses of the USB 2.0 plug. The USB 2.0 plug is thus connected to the connector.

When the USB 2.0 plug is pulled out of the slot of the connector, the first and second locking pieces 311, 312 are disengaged from the recesses of the USB 2.0 plug. The straight portions 212b, 222b, 232b, 242b move in the X direction back to their original positions, and the contact portions 211b, 221b, 231b, 241b are displaced inside the grooves 112a in the X direction.

When a USB 3.0 plug is inserted into the slot of the connector, the contacts of the USB 3.0 plug come into contact with the contact portions 211a, 221a, 231a, 241a, 251a of the first, second and fourth contacts 210a, 220a, 230a, 240a, 250a. Then, the first and second locking pieces 311, 312 of the shell 300 are locked in recesses of the USB 3.0 plug. The USB 3.0 plug is thus connected to the connector. The straight portions 212b, 222b, 232b, 242b of the third contacts 210b, 220b, 230b, 240b are pressed by the USB 3.0 plug and elastically deform in the −X direction, and the contact portions 211b, 221b, 231b, 241b are displaced inside the grooves 112a in the −X direction.

When the USB 3.0 plug is pulled out of the slot of the connector, the first and second locking pieces 311, 312 are disengaged from the recesses of the USB 3.0 plug. Then the pressing force on the straight portions 212b, 222b, 232b, 242b is released to allow them move in the X direction back to their original positions. The contact portions 211b, 221b, 231b, 241b are displaced in the grooves 112a in the X direction.

The above-described connector has many technical features. Particularly, the contact portions 211a, 221b of the first and second contacts 210a, 220a are arranged at spaced intervals along the −Z direction, and the first straight portions 212a, 222a extend in the Y direction. The first bent portions 213a, 223a are bent in the direction including components of X, Y, and −Z directions, the intermediate portions 214a, 224a extend in the same direction, and the second bent portions 215a, 225a are bent in the −Z direction. The second straight portions 216a, 226a extend in the −Z direction, and the tails 217a, 227a are arranged at spaced intervals along the Y direction. The first straight portion 222a has a larger length than the first straight portion 212a, and the second straight portion 226a has a smaller length than the second straight portion 216a by substantially the same amount as the difference in length between the first straight portion 222a and the first straight portion 212a. This configuration makes it possible to substantially equalize the overall lengths of the first and second contacts 210a, 220a and arrange them in parallel to each other. Moreover, the first and second contacts 210a, 220a are arranged in such a manner as to substantially equalize the distances between the first straight portions 212a, 222a, between the first bent portions 213a, 223a, between the intermediate portions 214a, 224a, between the second bent portions 215a, 225a, and between the second straight portions 216a, 226a. This disposition of the first and second contacts 210a, 220a can reduce the occurrence of skew and match the impedances between the two contacts. Similarly to the first and second contacts 210a, 220a, the first and second contacts 240a, 250a are also configured to reduce the occurrence of skew and match the impedances between the two contacts. In addition, the first and second contacts 210a, 220a, 240a, 250a are of such shapes as to extend substantially in parallel to one another through their lengths, so that the contacts can be manufactured by press-molding at a time. Consequently, it is possible to reduce the number of dies for manufacturing the first and second contacts 210a, 220a, 240a, 250a and therefore possible to reduce costs for the connector.

Further advantageously, the inclined portion 213b of the second contact 210b is disposed in the vicinity in the −Z direction of the first bent portions 213a, 223a, 233a, 243a, 253a, the intermediate portions 214a, 224a, 234a, 244a, 254a, and the second bent portions 215a, 225a, 235a, 245a, 255a. On the other hand, the back cover 330 of the shell 300 is disposed in the vicinity in the Z direction of the first bent portions 213a, 223a, 233a, 243a, 253a, the intermediate portions 214a, 224a, 234a, 244a, 254a, and the second bent portions 215a, 225a, 235a, 245a, 255a. This arrangement makes it possible to reduce the impedances of the portions exposed from the first and second bodies 100a, 100b, namely the first bent portions 213a, 223a, 243a, 253a, the intermediate portions 214a, 224a, 244a, 254a, and the second bent portions 215a, 225a, 245a, 255a. This results in matched impedances between the first and second contacts 210a, 220a and between the first and second contacts 240a, 250a.

Further, the first, second and fourth contacts 210a, 220a, 230a, 240a, 250a are contacts for high-speed digital signal transmission in compliance with the USB 3.0 standard, while the third contacts 210b, 220b, 230b, 240b are contacts for low-speed digital signal transmission in compliance with the USB 2.0 standard. The third contacts 210b, 220b, 230b, 240b are arranged in the region between the first straight portions 212a, 222a, 232a, 242a, 252a and the second straight portions 216a, 226a, 236a, 246a, 256a of the first, second and fourth contacts 210a, 220a, 230a, 240a, 250a. This arrangement of the contacts contributes to the reduction in cross talk between the first straight portions 212a, 222a, 232a, 242a, 252a and the second straight portions 216a, 226a, 236a, 246a, 256a. Also, the region to dispose the third contacts 210b, 220b, 230b, 240b is otherwise unused space of the connector, leading to reduction in dimension in the X and −X directions of the connector.

The present connector is also advantageous in assembly. In the first, second and fourth contacts 210a, 220a, 230a, 240a, 250a, the contact portions 211a, 221a, 231a, 241a, 251a and the first straight portions 212a, 222a, 232a, 242a, 252a are held in the first body 100a, and the second straight portions 216a, 226a, 236a, 246a, 256a are held in the second body 100b. In the third contacts 210b, 220b, 230b, 240b, the inclined portions 213b, 223b, 233b, 243b and the Y direction ends of the straight portions 212b, 222b, 232b, 242b are held in the third body 100c. After inserting the straight portions 212b, 222b, 232b, 242b into the grooves 112a of the first body 100a and combining the first and third bodies 100a, 100b, the first bent portions 213a, 223a, 243a, 253a and the second bent portions 215a, 225a, 245a, 255a of the first, second and fourth contacts 210a, 220a, 230a, 240a, 250a are bent, and thereby the third body 100c is held between the first body 100a and the second body 100b. As a result, the third contacts 210b, 220b, 230b, 240b can be easily disposed in the region between the first straight portions 212a, 222a, 232a, 242a, 252a and the second straight portions 216a, 226a, 236a, 246a, 256a of the first contact group 200a. It is thus advantageously easy to assemble the connector. Further, the first bent portions 213a, 223a, 243a, 253a and the second bent portions 215a, 225a, 245a, 255a are bent in the state where the contact portions 211a, 221a, 231a, 241a, 251a and the first straight portions 212a, 222a, 232a, 242a, 252a are held in the first body 100a and the second straight portions 216a, 226a, 236a, 246a, 256a are held in the second body 100b. The bending step of the first bent portions 213a, 223a, 243a, 253a, and the second bent portions 215a, 225a, 245a, 255a is less likely to cause variations in shape and/or disposition of the first, second and fourth contacts 210a, 220a, 230a, 240a, 250a.

The above described connector is not limited to the above-described embodiment, and it may be modified in design in any manner within the scope of Claims. Modification examples will be described in detail below.

The connector of the above embodiment includes the first and second contacts 210a, 220a having substantially the same overall length, the fourth contact 230a, and the first and second contacts 240a, 250a having substantially the same overall length. The connector of the invention at least requires first and second contacts having substantially the same overall length. In other words, either the first and second contacts 210a, 220a or the first and second contacts 240a, 250a may be omitted. The third contact can be omitted.

The contact portions 211a, 221a of the first and second contacts 210a, 220a of the above embodiment are embedded in the first body 100a at spaced intervals along the −Z direction. However, the contact portions of the first and second contacts of the invention may be modified as long as they are spaced along the −Z direction. For example, in the case where the first straight portions of the first and second contacts are press-fitted into grooves or holes of the first body as described below, the contact portions of the first and second contacts may be received in the grooves or holes of the first body to be arranged at spaced intervals along the −Z direction.

The first straight portions 212a, 222a of the first and second contacts 210a, 220a of the above embodiment extend in the Y direction and are embedded in the first body 100a at spaced intervals in the −Z direction. The first straight portions of the first and second contacts of the invention may be modified as long as they are continuous with the contact portions, extend in the Y direction, and the first straight portion of the second contact has a larger length than the first straight portion of the first contact.

The first bent portions 213a, 223a of the first and second contacts 210a, 220a of the above embodiment are bent in the direction including components of the X, Y, and −Z directions. However, the first bent portions of the first and second contacts of the invention may be modified as long as they are continuous with the first straight portions and bent in a direction including a component of the X direction orthogonal to the Y direction. For example, the first bent portions of the first and second contacts may be bent in the X direction or in a direction including components of the X, Y, and Z directions, the X, −Y, and −Z directions, or the X, −Y and Z directions.

The intermediate portions 214a, 224a of the first and second contacts 210a, 220a of the above embodiment are continuous with the first bent portions 213a, 223a, and extend straight in the direction including components of the X, Y, and −Z directions. However, the intermediate portions of the first and second contacts of the invention may be modified as long as they are continuous with the first and second bent portions and connect between the first and second bent portions. For example, the intermediate portions of the first and second contacts may be of arc shape generally extending in the X direction, or in a direction including components of the X, Y, and Z directions, the X, Y, and −Z directions, the X, −Y, and −Z directions, or the X, −Y, and Z directions. Alternatively, the intermediate portions of the first and second contacts may extend straight generally in the X direction or in a direction including components of the X, Y, and Z directions, the X, −Y, and −Z directions, or the X, −Y, and Z directions.

The second bent portions 215a, 225a of the first and second contacts 210a, 220a of the above embodiment are continuous with the intermediate portions 214a, 224a, respectively, and are bent in the −Z direction. However, the second bent portions of the first and second contacts of the invention may be modified as long as they are continuous with the intermediate portions and bent in a direction including a component of the −Z direction orthogonal to the Y direction and to the X direction. For example, the second bent portions of the first and second contacts may extend in a direction including components of the Y and −Z directions, the −Y and −Z directions, the X, Y, and −Z directions, the X, −Y, and −Z directions, the −X, Y, and −Z directions, or the −X, −Y, and −Z directions.

The first bent portions 212a, 222a, the intermediate portions 214a, 224a, and the second bent portions 215a, 225a of the above embodiment are exposed from the first and second bodies 100a, 100b. However, the first bent portions, the intermediate portions, and the second bent portions of the first and second contacts of the invention may be embedded or accommodated in a body or bodies. Alternatively, the first and second contacts may be exposed from a body or bodies only in the intermediate portions, or in the intermediate portions and the first bent portions, or in the intermediate portions and the second bent portions.

The second straight portions 216a, 226a of the first and second contacts 210a, 220a of the above embodiment are continuous with the second bent portions 215a, 225a, and they extend in the −Z direction. However, the second straight portions of the first and second contacts of the invention may be modified as long as they are continuous with the second bent portions and extend in a direction including a component of the −Z direction, and as long as the second straight portion of the second contact has a smaller length than the second straight portion of the first contact. Accordingly, the length of the second straight portion of the second contact need not be smaller than the length of the second straight portion of the first contact by substantially the same amount as the difference in length between the first straight portion of the second contact and the first straight portion of the first contact.

The tails 217a, 227a of the first and second contacts 210a, 220a of the above embodiment are plates continuous with the second straight portions 216a, 226a, respectively, and they are arranged in spaced intervals along the Y direction. However, the tails of the first and second contacts of the invention may be modified as long as they are continuous with the second straight portions and are spaced along the Y direction. For example, the tails may be bent in a substantially L shape for surface-mounting an electrode etc. on the circuit board.

The first bent portions of the first and second contacts may be replaced with first curved portions continuous with the first straight portions and curved in a direction including a component of the second direction orthogonal to the first direction. The second bent portions of the first and second contacts in accordance with the embodiment and the modification examples as described above may be replaced with second curved portions continuous with the intermediate portions and curved in a direction including a component of the third direction orthogonal to the first and second directions. In this case, the intermediate portions may be provided between the first and second curved portions, and the second straight portions may be continuous with the second curved portions. The first and second bent portions may be smoothly bent to form first and second curved portions. Modification examples described above with respect to the first and second contacts 210a, 220a are applicable to the first and second contacts 240a, 250a. The first and second contacts may constitute differential pairs as described above or may be used as contacts for single-ended signaling.

The fourth contact 230a of the above embodiment has the contact portion 231a, the first straight portion 232a, the first bent portion 233a, the intermediate portion 234a, the second bent portion 235a, the second straight portion 236a, and the tail 237a. However, the fourth contact of the invention may have any other configuration. More particularly, the contact portion, the first straight portion, the first bent portion, the intermediate portion, the second bent portion, the second straight portion, and the tail of the fourth contact may be modified in a similar manner to the modification examples described above with respect to the first bent portion, the intermediate portion, the second bent portion, the second straight portion, and the tail, respectively of the first and second contacts. The first and second bent portions of the fourth contact can be replaced with first and second curved portions in a similar manner as in the first and second contacts. The first and second bent portions may be smoothly bent to form first and second curved portions.

The third contacts 210b, 220b, 230b, 240b of the above embodiment are disposed in the region between the first straight portions 212a, 222a, 232a, 242a, 252a of the first contact group 200a and the second straight portions 216a, 226a, 236a, 246a, 256a of the first contact group 200a. However, the third contacts may be modified as long as they are held in the body and arranged in spaced intervals along the X or −X direction to extend substantially in parallel to the first straight portions of the first and second contacts. As the third contacts are arranged in spaced intervals along the X or −X direction to extend substantially in parallel to the first straight portions of the first and second contacts, the third contacts can function as ground contacts or pseudo ground contacts for the first and second contacts. The third contacts therefore contribute to matched impedances between the first contacts and the second contacts. The connector of the invention requires at least one third contact.

The third contacts of the above embodiment each include the contact portion, the straight portion, the inclined portion, and the tail. However, the third contact or contacts of the invention may be modified in shape. The straight portion of each third contact may or may not be elastically deformable. For example, the contact portion and the straight portion of the third contact may be held or embedded in the body in an undeformable manner.

The inclined portion 213b of the third contact 210b of the above embodiment is located in the vicinity on the −Z direction side of the first bent portions 213a, 223a, 233a, 243a, 253a, the intermediate portions 214a, 224a, 234a, 244a, 254a, and the second bent portions 215a, 225a, 235a, 245a, 255a. However, this may not be the case if the first bent portions 213a, 223a, 233a, 243a, 253a, the intermediate portions 214a, 224a, 234a, 244a, 254a, and the second bent portions 215a, 225a, 235a, 245a, 255a are modified to be disposed in the body as described above. In the case where the first and second contacts include the first and second curved portions in place of the first and second bent portions, the inclined portions may be located in the vicinity on the −Z direction side of the first curved portions, the intermediate portions, and the second curved portions as in the embodiment. Alternatively, the inclined portions may not be located in the vicinity on the −Z direction side of the first curved portions, the intermediate portions, and the second curved portions.

The distances D1, D2, and D3 of the above embodiment are adjusted in accordance with the difference between the impedance I1 (the impedance of the first bent portions 213a, 223a, 243a, 253a, the intermediate portions 214a, 224a, 244a, 254a, and the second bent portion 215a, 225a, 245a, 255a of the first and second contacts 210a, 220a, 240a, 250a) and the reference impedance I2 required of the present connector. However, the relationship among the distances D1, D2, and D3 may be determined otherwise. An alternative means to match the impedance of the first bent portions, the intermediate portion, and the second bent portions of the first and second contacts with the reference impedance is simply to dispose the inclined portions of the third contacts substantially in parallel to the intermediate portions of the first and second contacts. Another alternative means is to adjust the shape (for example, degree of bending) of the first bent portions 213a, 223a, 233a, 243a, 253a, the intermediate portions 214a, 224a, 234a, 244a, 254a, and the second bent portions 215a, 225a, 235a, 245a, 255a. A further alternative means is to adjust the thickness (dimension in the X and −X directions) of the inclined portion 213b. In the connector of the above embodiment, the inclined face 213b1 of the inclined portion 213b is exposed from the sloped face of the third body 100c. However, the inclined portion of the invention may be embedded in the body. In the case where the first and second contacts include the first and second curved portions in place of the first and second bent portions, the relationship among the distances D1, D2, and D3 may be set as in the embodiment or as described in this paragraph. The reference impedance I2 of the above embodiment is set to 90 to 100Ω, but it is not limited to this. For example, in the case where the first and second contacts are for single-ended signaling, the reference impedance may be set to 45Ω to 50Ω.

The body 100 of the above embodiment consists of the first, second, and third bodies 100a, 100b, 100c. However, the body of the invention may be any insulative body adapted to hold the first and second contacts. For example, the body may consist of a first body for holding the contact portions and the first straight portions of the first and second contacts and a second body for holding the second straight portions of the first and second contacts. In this case, the third contact or contacts may be omitted or may be held in the first body or the second body.

The first body 100a of the above embodiment holds the contact portions 211a, 221a, 231a, 241a, 251a and the first straight portions 212a, 222a, 232a, 242a, 252a of the first, second, and fourth contacts 210a, 220a, 230a, 240a, 250a in an embedded manner. However, the first body of the invention may be any insulative body adapted to hold the first straight portions of the first and second contacts. For example, the first straight portions of the first and second contacts may be press-fitted into grooves or holes formed in the first body.

The second body 100b of the above embodiment holds the second straight portions 216a, 226a, 236a, 246a, 256a of the first, second, and fourth contacts 210a, 220a, 230a, 240a, 250a in an embedded manner. However, the second body of the invention may be any insulative body adapted to hold the second straight portions of the first and second contacts. For example, the second straight portions of the first and second contacts may be press-fitted into grooves or holes formed in the second body.

The third body 100c of the above embodiment holds the inclined portions 213b, 223b, 233b, 243b of the third contacts 210b, 220b, 230b, 240b and the Y direction ends of the straight portions 212b, 222b, 232b, 242b in an embedded manner. However, the third body of the invention may be any insulative body adapted to hold the inclined portions of the third contacts. For example, the inclined portions of the third contacts may be press-fitted into grooves formed in the third body.

In the connector of the above embodiment, the block 110c of the third body 100c is fitted in the accommodation space a of the first body 100a, and the plate 130c is held between the proximal portion 120a of the first body 100a and the second body 100b. However, the third body may be of any configuration adapted to be disposed between the first and second bodies.

The connector of the above embodiment includes the shell 300. However, the shell 300 can be omitted. Alternatively, the shell of the invention may be any electrically conductive shell adapted to surround the body holding the first and second contacts or holding the first, second, third contacts. For example, the shell may be formed by casting some metal. Alternatively, the shell may be formed of insulating resin with electrically conductive metal deposited thereon.

In the connector of the above embodiment, the back cover 330 of the shell 300 is disposed in the vicinity on the Z direction side of the first bent portions 213a, 223a, 243a, 253a, the intermediate portions 214a, 224a, 244a, 254a, and the second bent portions 215a, 225a, 245a, 255a to function as the impedance adjusting portion. However, the impedance adjusting portion of the invention may be any part of the shell adapted to be disposed in the vicinity of the intermediate portions of the first and second contacts.

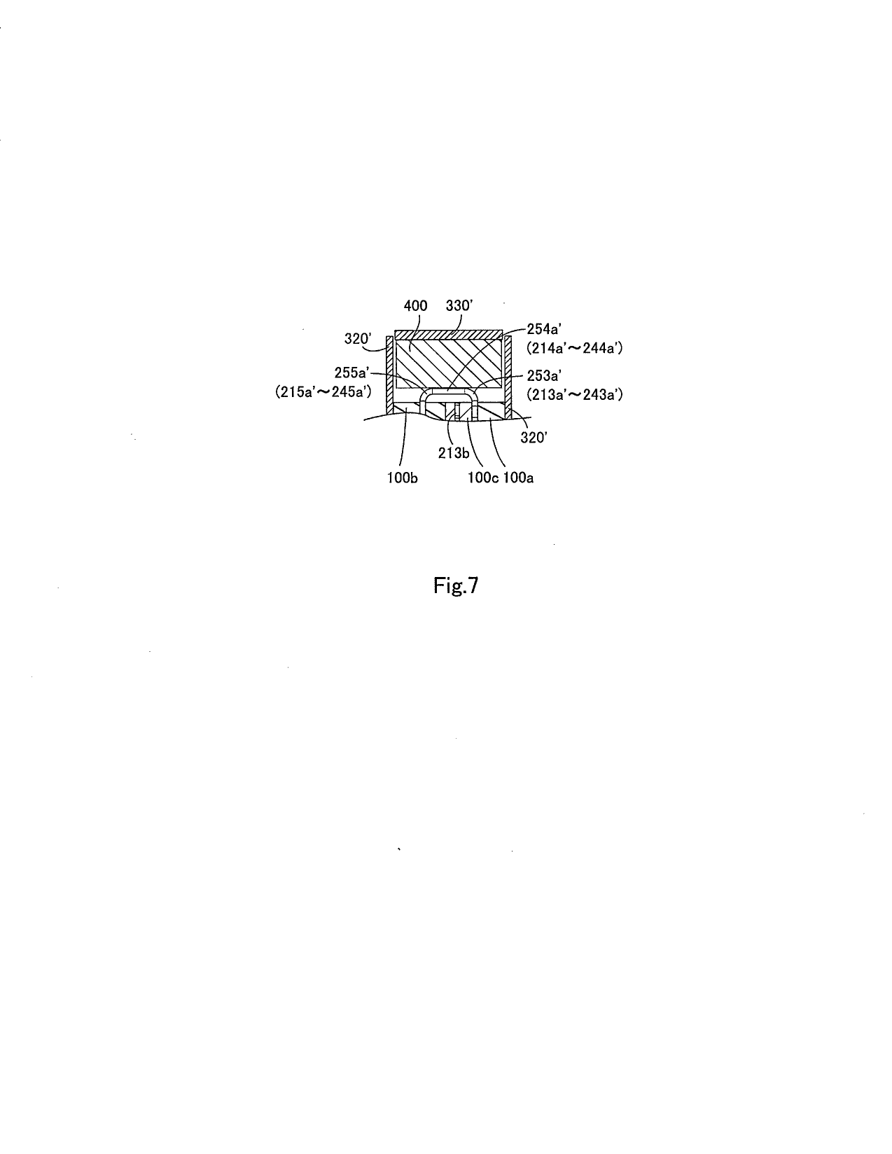

The connector of the invention may further include a dielectric member provided between the intermediate portions of the first and second contact as exposed from the bodies and the shell. By way of example, FIG. 7 illustrates a dielectric member 400 made of the same insulating resin as the first, second, and third bodies 100a, 100b, 100c. The dielectric member 400 is disposed between intermediate portions 214a′, 224a′, 234a′, 244a′, 254a′ of first, second and fourth contacts 210a′, 220a′, 230a′, 240a′, 250a′ and a back cover 330′. FIG. 7 also illustrates first bent portions 213a′, 223a′, 233a′, 243a′, 253a′ of the first, second and fourth contacts; second bent portions 215a′, 225a′, 235a′, 245a′, 255a′ of the first, second and fourth contacts; an inclined portion 213b of the third contact; and an extended portion 320′ of the shell.

It should be appreciated that the above-described preferred embodiment and modification examples are described by way of examples only. The material, shape, dimensions, number, arrangement, and other features of each constituent element of the connector may be modified as long as the same functions are provided. The connector of the above embodiment is a receptacle connector. However, the connector of the invention may be a plug connector, which may include tails or a circuit board for connection with a cable. The X and −X directions, the Y and −Y directions, and the Z and −Z directions are defined for the convenience of description, and they are not limited to the definition of the embodiment. The X and −X directions, the Y and −Y directions, and the Z and −Z directions may be any other directions of the connector. The first and second contacts may be press-molded as in the embodiment, but they may be casted or may be formed in any other means.

### REFERENCE SIGNS LIST

100: body
100a: first body
110a: distal portion
120a: proximal portion
130a: arm
100b: second body
100c: third body
110c: block
120c: tongue
130c: plate
200a: first contact group
210a: first contact
211a: contact portion
212a: first straight portion
213a: first bent portion
214a: intermediate portion
215a: second bent portion
216a: second straight portion
217a: tail
220a: second contact
221a: contact portion
222a: first straight portion
223a: first bent portion
224a: intermediate portion
225a: second bent portion
226a: second straight portion
227a: tail
230a: fourth contact
231a: contact portion
232a: first straight portion
233a: first bent portion
234a: intermediate portion
235a: second bent portion
236a: second straight portion
237a: tail
240a: first contact
241a: contact portion
242a: first straight portion
243a: first bent portion
244a: intermediate portion
245a: second bent portion
246a: second straight portion
247a: tail
250a: second contact
251a: contact portion
252a: first straight portion
253a: first bent portion
254a: intermediate portion
255a: second bent portion
256a: second straight portion
257a: tail
200b: second contact group
210b to 240b: third contact
211b to 241b: contact portion
212b to 242b: straight portion
213b to 243b: inclined portion
214b to 244b: tail
300: shell
310: square cylindrical portion
320: extending portion
330: back cover (impedance adjusting portion)
340: engaging portion
350: first leg
360: second leg

1. A connector comprising:
a body of insulation; and
first and second contacts being adapted to be held in the body and having substantially the same overall length,
the first contact including:
a contact portion;
a first straight portion being continuous with the contact portion and extending in a first direction;
a first bent portion being continuous with the first straight portion and bent in a direction including a component of a second direction, the second direction being orthogonal to the first direction;
an intermediate portion being continuous with the first bent portion;
a second bent portion being continuous with the intermediate portion and bent in a direction including a component of a third direction, the third direction being orthogonal to the first and second directions;
a second straight portion being continuous with the second bent portion and extending in the direction including the component of the third direction; and
a tail being continuous with the second straight portion, and the second contact includes:
a contact portion being spaced apart in the third direction from the contact portion of the first contact;
a first straight portion being continuous with the contact portion of the second contact, extending in the first direction, and having a larger length than the first straight portion of the first contact;
a first bent portion being continuous with the first straight portion of the second contact and bent in the same direction as the bending direction of the first bent portion of the first contact;
an intermediate portion being continuous with the first bent portion of the second contact;
a second bent portion being continuous with the intermediate portion of the second contact and bent in the same direction as the bending direction of the second bent portion of the first contact;
a second straight portion being continuous with the second bent portion of the second contact, extending along the second straight portion of the first contact, and having a smaller length than the second straight portion of the first contact; and
a tail being continuous with the second straight portion of the second contact and being spaced apart in the first direction from the tail of the first contact.

2. The connector according to claim 1, wherein the first and second bent portions of the first and second contacts are smoothly bent.

3. The connector according to claim 1, wherein
the length of the second straight portion of the second contact is smaller than the length of the second straight portion of the first contact by substantially the same amount as the difference in length between the first straight portion of the first contact and the first straight portion of the second contact.

4. The connector according to claim 1, further comprising a third contact held in the body, the third contact being disposed in spaced relation to the first straight portions of the first and second contacts in the second direction or a direction opposite to the second direction so as to extend substantially in parallel to the first straight portions of the first and second contacts.

5. The connector according to claim 4, wherein
the third contact is disposed in a region defined between the first straight portions of the first and second contacts and the second straight portions of the first and second contacts.

6. The connector according to claim 5, the third contact comprising:
a contact portion;
a straight portion being continuous with the contact portion of the third contact, extending in the first direction, and spaced apart in the second direction from the first straight portions of the first and second contacts;
an inclined portion being continuous with the straight portion and obliquely inclined with respect to the straight portion, the inclined portions being disposed between the first straight portions of the first and second contacts and the second straight portions of the first and second contacts; and
a tail being continuous with the inclined portion.

7. The connector according to claim 6, wherein
the inclined portion of the third contact extends substantially in parallel to the intermediate portions of the first and second contacts.

8. The connector according to claim 1, wherein
the body includes:
a first body for holding the contact portions and the first straight portions of the first and second contacts; and
a second body for holding the second straight portions of the first and second contacts.

9. The connector according to claim 6, wherein
the body includes:
a first body for holding the contact portions and the first straight portions of the first and second contacts;
a second body for holding the second straight portions of the first and second contacts; and
a third body for holding the inclined portion of the third contact, the third body being disposed between the first and second bodies.

10. The connector according to claim 1, further comprising a shell with electrical conductivity for surrounding the body, wherein
the intermediate portions of the first and second contacts are exposed from the body, and
the shell includes an impedance adjusting portion to be disposed in the vicinity of the intermediate portions of the first and second contacts.

11. The connector according to claim 1, further comprising:
a shell with electrical conductivity for surrounding the body; and
a dielectric member provided between the intermediate portions exposed from the bodies of the first and second contacts and the shell.

12. The connector according to claim 6, further comprising:
first and second differential pairs, each pair including the first and second contacts arranged in spaced relation in the third direction; and
a fourth contact disposed between the first and second differential pairs, wherein
the third contact comprises a plurality of the third contacts, the third contacts being arranged in said region in such a manner that the straight portions thereof are located between the first straight portions of the first and second contacts of the first differential pair, between the first straight portions of the first and second contacts of the second differential pair, between the first straight portion of the second contact of the first differential pair and the fourth contact, and between the first straight portion of the first contact of the second differential pair and the fourth contact.

13. The connector according to claim 12, wherein
the contact portions and the first straight portions of the first and second contacts are fixed to the body,
the inclined portions of the third contacts are fixed to the body, and
the straight portions of the third contacts are elastically deformable toward the first straight portions of the first and second contacts.

14. The connector according to claim 1, wherein
the first bent portions of the first and second contacts are bent in a direction including components of the first, second, and third directions, and
the intermediate portions of the first and second contacts extend in the direction including components of the first, second, and third directions.
